(19) United States
(12) Patent Application Publication
(10) Pub. No.: US 2012/0195044 A1
(43) Pub. Date: Aug. 2, 2012

(54) ILLUMINATING DEVICE AND ILLUMINATING SYSTEM

(75) Inventor: Yoshihiro Higuchi, Saitama (JP)

(73) Assignee: HST VISION CORPORATION, Saitama (JP)

(21) Appl. No.: 13/501,008

(22) PCT Filed: Oct. 20, 2010
(86) PCT No.: PCT/JP2010/068479

§ 371 Date: Apr. 9, 2012

(30) Foreign Application Priority Data
Oct. 29, 2009 (JP) 2009-248465

(51) Int. Cl. F21V 21/14; F21V 21/00

(52) U.S. Cl. 362/249.03; 362/249.02

(57) ABSTRACT

LEDs (21, 22, 23) are arranged on a substrate provided on a illuminating device (14), wherein the orientation of the LEDs (21, 22, 23) are set such that the angle (α) formed from the X axis and the orthogonal projection onto the X-Y plane of the light emitting main axes (L1, L2, L3) of the LEDs (21, 22, 23) is between 15 and 75 degrees, inclusive, and the angle (β) formed from the Y axis and the orthogonal projection onto the Y-Z plane of the light emitting main axes (L1, L2, L3) is between 0 and 75 degrees, inclusive.

### TECHNICAL FIELD

The present invention relates to an illuminating device, which irradiates light to an observation object in order to observe circuits, identification symbols (ID), characters, patterns, foreign matters and defects formed on observation objects such as semiconductor wafers, glasses and flexible printed circuit boards (FPC), and to an illuminating system.

### BACKGROUND ART

In general, microscopes such as a stereomicroscope and a differential interference microscope are used to observe circuits, ID, characters, patterns, foreign matters and defects formed on observation objects such as semiconductor wafers, glasses and flexible printed circuit boards (FPC). A dedicated illuminating device is used to observe an observation object using the foregoing microscopes. The foregoing illuminating device properly irradiates light to the observation object, and thereby, it is possible to properly observe an image of the observation object by human eyes and a camera. Further, it is possible to read characters formed on the observation object, or to detect defects. For example, the following illuminations are known as the foregoing illuminating device (see Patent document 1). Specifically, a circular or straight-tube fluorescent lamp illumination, a ring illumination having ring-arranged light sources and a bar illumination having two-dimensionally arranged light emitting diodes (LED) are given.

Moreover, the following image processor is known. Specifically, the image processor includes a dedicated optical system, which is optically designed, and a camera, and irradiates light to an observation object via the dedicated optical system. Further, the image processor shoots the observation object using the camera, and inputs an image of the shot observation object as an image data to a data processor comprising a personal computer and a digital signal processor (DSP). Furthermore, the image processor operates a dedicated image processing program to recognize an ID formed on the observation object or to detect defects.
Prior Art Document: Jpn. Pat. Appln. KOKAI Publication No. 11-242002

### DISCLOSURE OF INVENTION

### Problem that Invention is to Solve

For example, a semiconductor wafer given as an observation object is horizontally arranged below an observing device such as a microscope or camera. An optical axis of a lens of the observing device is set to cross at right angles to one point on the surface of a semiconductor wafer. Then, an illuminating device is provided above the semiconductor wafer and at a position separating from the optical axis of the lens of the observing device. Illumination light emitting from the illuminating device is irradiated to a predetermined area so that the light is incident at an angle of 45 degrees to the surface of the semiconductor wafer. The predetermined area is an area around a point on which the optical axis of the lens of the observing device and the surface of the semiconductor wafer meet at right angles.

In such a system, a straight line showing the orientation of illumination light, that is, an orthogonal projection to the surface of the semiconductor wafer of a light emitting main axis of the illumination light is parallel with an extending direction of a circuit interconnect formed on the semiconductor wafer. In this case, the illumination light sufficiently reflects or scatters onto the circuit interconnect formed on the semiconductor wafer. As a result, the circuit interconnect is brightly reflected in the observing device. Moreover, an orthogonal projection to the surface of the semiconductor wafer of a light emitting main axis of the illumination light and an extending direction of a circuit interconnect formed on the semiconductor wafer meet at right angles. In also case, the illumination light sufficiently reflects or scatters onto the circuit interconnect formed on the semiconductor wafer. As a result, the circuit interconnect is brightly reflected in the observing device. However, if the orthogonal projection to the surface of the semiconductor wafer of a light emitting main axis of the illumination light and the extending direction of a circuit interconnect formed on the semiconductor wafer cross at an angle of 45 degrees, the following problem arises. Namely, the illumination light does not sufficiently reflect or scatters onto the circuit interconnect formed on the semiconductor wafer. As a result, the circuit interconnect is darkly reflected in the observing device.

On the other hand, identification (ID) is marked on the surface of a semiconductor wafer. For example, the foregoing ID is an identification symbol given for manufacture management. The foregoing illumination light is irradiated to the ID. In this case, even if the orientation of the orthogonal projection to the surface of the semiconductor wafer of a light emitting main axis of the illumination light is set to what direction, the illumination light sufficiently reflects or scatters onto ID so long as it is irradiated to ID. As a result, the ID is brightly reflected in the observing device.

Therefore, if the observing device reads the ID marked on the surface of a semiconductor wafer, it is preferable that the orientation of the illumination light is set to satisfy the following condition. Specifically, the orientation of the illumination light is set so that the orthogonal projection to the surface of the semiconductor wafer of a light emitting main axis of the illumination light and the extending direction of a circuit interconnect formed on the semiconductor wafer cross at an angle of 45 degrees. If the orientation of the illumination light is set to satisfy the foregoing condition, the following advantage is obtained in the observing device. Specifically, the circuit interconnect formed on the semiconductor wafer is darkly reflected while the ID marked on the surface of the semiconductor wafer is brightly reflected. As a result, it is possible to brightly reflect the ID only, and to easily and securely read the ID.

The condition described above has been suggested in the foregoing Patent document 1. However, according to an experiment made by inventors of the invention, the following point is found. Specifically, it is not limited to the condition that the orthogonal projection to the surface of the semiconductor wafer of a light emitting main axis of the illumination light and the extending direction of a circuit interconnect formed on the semiconductor wafer does not cross at an angle of 45 degrees. Even if the orientation of the illumination light is set so that the foregoing orthogonal projection and extending direction cross at an angle of about 15 to 75 degrees, the foregoing advantage is obtained in the observing device. Namely, the circuit interconnect formed on the semiconductor wafer is darkly reflected while the ID marked on the surface of the semiconductor wafer is brightly reflected.

On the other hand, if a general bar illumination (line illumination) is used as an illuminating device in the foregoing system, the following problems arise.

Specifically, it is a frequent occurrence that ID marked on a semiconductor wafer is arranged in the direction parallel to the extending direction of circuit interconnects. For example, a general bar illumination is formed in a manner that a plurality of light emitting diodes (LEDs) is arranged in one direction. The arrangement direction of the foregoing LEDs and the orientation of illumination light cross each other at right angles. As a result, an irradiation area of illumination light of the bar illumination has a long extending shape to the direction orthogonal to the orientation of illumination light. This is a factor of causing the following problem. Namely, the orientation of illumination light of the bar illumination is set so that the orientation of the illumination light is set so that the orthogonal projection to the surface of the semiconductor wafer of a light emitting main axis of the illumination light and the extending direction of a circuit interconnect formed on the semiconductor wafer cross at an angle of 45 degrees, for example. For this reason, on the semiconductor wafer, the extending direction of the irradiation area of illumination light by the bar illumination and the arrangement direction of ID mutually shift at an angle of 45 degrees. As a result, a part of the whole of the ID is merely irradiated; in other words, an area where the illumination area of the illumination light and the ID cross is merely irradiated. Therefore, it is impossible to irradiate the whole of the ID by the bar illumination at one time.

In the bar illumination, the number of columns arranging LEDs is increased to enlarge the irradiation area, and thereby, it is possible to irradiate the whole of the ID at one time. However, in this case, the irradiation area is too wide to be enlarged, and thereafter, the illumination light is irradiated to an unnecessary area; for this reason, the efficiency is worsened. As a result, this is a factor of causing large scale and weight increase of an illuminating device and an increase of power consumption. The foregoing problem arises in bar or line illumination using a straight-tube fluorescent lamp.

The present invention has been made in view of the foregoing problem. An object of the present invention is to provide an illuminating device, which can readily and effectively realize a high-accurate observation of ID, characters, foreign matters and defects formed on an object such as a semiconductor wafer.

### Means for Solving the Problem

In order to solve the foregoing problem, a first illuminating device of the invention is characterized in that an illuminating device for irradiating light to an object in order to observe or shoot the object on an object placement plane by an observing device or camera device, comprises: a substrate; a support member configured to support the substrate; and a plurality of light emitting members arranged on a surface of the substrate, wherein in a three-dimensional space defined by X and Y axes parallel to the object placement plane and crossing each other at right angles, and by a Z axis crossing at right angles with the X and Y axes, a direction of each light emitting member is set so that an angle made by an orthogonal projection of a light emitting main axis of each light emitting member to an X-Y plane and by the X axis is between 15 and 75 degrees, and an angle made by an orthogonal projection of a light emitting main axis of each light emitting member to a Y-Z plane and by the Y axis is between 0 and 75 degrees.

In order to solve the foregoing problem, a second illuminating device of the invention is characterized in the first illuminating device that the light emitting members are arranged linearly on the surface of the substrate.

In order to solve the foregoing problem, a third illuminating device of the invention is characterized in the first or second illuminating device that the light emitting main axes of the light emitting members are parallel to each other.

In order to solve the foregoing problem, a fourth illuminating device of the invention is characterized in the first illuminating device that the light emitting members comprises a plurality of first-group light emitting members and a plurality of second-group light emitting members at least, the first-group light emitting members are arranged linearly on the surface of the substrate, the second-group light emitting members are arranged linearly on the surface of the substrate, and the first- and second-group light emitting members are arranged in at least two lines on the surface of the substrate so that their arrangement directions are parallel.

In order to solve the foregoing problem, a fifth illuminating device of the invention is characterized in the first illuminating device that the light emitting members comprises a plurality of first-group light emitting members and a plurality of second-group light emitting members at least, the first-group light emitting members are arranged linearly on the surface of the substrate so that their light emitting main axes are parallel to each other, the second-group light emitting members are arranged linearly on the surface of the substrate so that their light emitting main axes are parallel to each other, the first- and second-group light emitting members are arranged in line on the surface of the substrate so that their arrangement directions coincide with each other, and light emitting main axes of the first- and second-group light emitting members cross each other.

In order to solve the foregoing problem, a sixth illuminating device of the invention is characterized in the fourth or fifth illuminating device that further comprises control means for turning on the light emitting members every group.

In order to solve the foregoing problem, a seventh illuminating device of the invention is characterized in any of the first to sixth illuminating devices that the light emitting members are light emitting diodes including a pair of leads for applying a voltage by itself, the surface of the substrate is formed with a pair of connection holes for inserting a pair of leads of each light emitting member, and an opening of each connection hole in a pair of connection hole is arranged on a straight line vertical to an orthogonal projection of each light emitting member to the X-Y plane.

In order to solve the foregoing problem, an eighth illuminating device of the invention is characterized in any of the first to seventh illuminating devices that the surface of the substrate is provided with a positioning member for determining a direction of each light emitting member, and each light emitting member is attached onto the surface of the substrate via the positioning member.

In order to solve the foregoing problem, a first illuminating system of the invention is characterized by including: a plurality of illuminating devices comprising any of the first to eighth illuminating devices of the invention, which are arranged both sides or around an optical axis of the observing device or the camera directed to the object.

In order to solve the foregoing problem, a second illuminating system of the invention is characterized by including: an illuminating device comprising any of the first to eighth illuminating devices of the invention; and a support member configured to rotatably support the illuminating device, the illuminating device is rotated so that in the tree-dimensional space, a direction of each light emitting member is set so that an angle made by an orthogonal projection of a light emitting main axis of each light emitting member to an X-Y plane and by the X axis is between 15 and 75 degrees, or an angle made by an orthogonal projection of a light emitting main axis of each light emitting member to a Y-Z plane and by the Y axis is between 0 and 75 degrees.

### Effects of the Invention

According to the present invention, it is possible to readily and effectively realize a high-accurate observation of ID, characters, foreign matters and defects formed on an object such as a semiconductor wafer.

### BRIEF DESCRIPTION OF DRAWINGS

FIG. 1 is a perspective view showing an observation system including an illuminating device according to a first embodiment of the invention;

FIG. 2 is an enlarged perspective view showing an illuminating device and a wafer shown in FIG. 1;

FIG. 3 is a top plan view showing an observation system when viewed from the arrow III direction shown in FIG. 1;

FIG. 4 is a side view showing an observation system when viewed from the arrow IV shown in FIG. 1;

FIG. 5 is an explanatory view showing circuit interconnects formed on a wafer and ID marked thereon;

FIG. 6 is a bottom view showing an illuminating device shown in FIG. 1;

FIG. 7 is a bottom view showing an illuminating device in a state that light emitting diodes (LEDs) and positioning members are detached;

FIG. 8 is a cross-sectional view showing an illuminating device when viewed from the arrow VIII-VIII direction shown in FIG. 6;

FIG. 9 is a front view showing a light emitting diode (LED);

FIG. 10 is a cross-sectional view showing an illuminating device according to a second embodiment of the invention when viewed from the same position as FIG. 8;

FIG. 11 is a cross-sectional view showing an illuminating device according to a third embodiment of the invention when viewed from the same position as FIG. 8;

FIG. 12 is a cross-sectional view showing an illuminating device according to a fourth embodiment of the invention when viewed from the same position as FIG. 8;

FIG. 13 is a bottom view showing an illuminating device according to a fifth embodiment of the invention;

FIG. 14 is a bottom view showing an illuminating device according to a sixth embodiment of the invention;

FIG. 15 is a bottom view showing an illuminating system according to a seventh embodiment of the invention;

FIG. 16 is a bottom view showing a modification example of an illuminating system according to a seventh embodiment of the invention;

FIG. 17 is a bottom view showing another modification example of an illuminating system according to a seventh embodiment of the invention;

FIG. 18 is a side view showing an eighth embodiment of the invention;

FIG. 19 is a cross-sectional view showing an eighth embodiment of the invention;

FIG. 20 is a bottom view showing an eighth embodiment of the invention;

FIG. 21 is a view to explain another example of a LED arrangement pattern according to an embodiment of the invention;

FIG. 22 is a view to explain another example of a LED arrangement pattern according to an embodiment of the invention;

FIG. 23 is a view to explain another example of a LED arrangement pattern according to an embodiment of the invention; and

FIG. 24 is a view to explain another example of a LED arrangement pattern according to an embodiment of the invention.

### BEST MODE FOR CARRYING OUT THE INVENTION

Hereinafter, embodiments of the invention will be described with reference to the accompanying drawings.

### First Embodiment

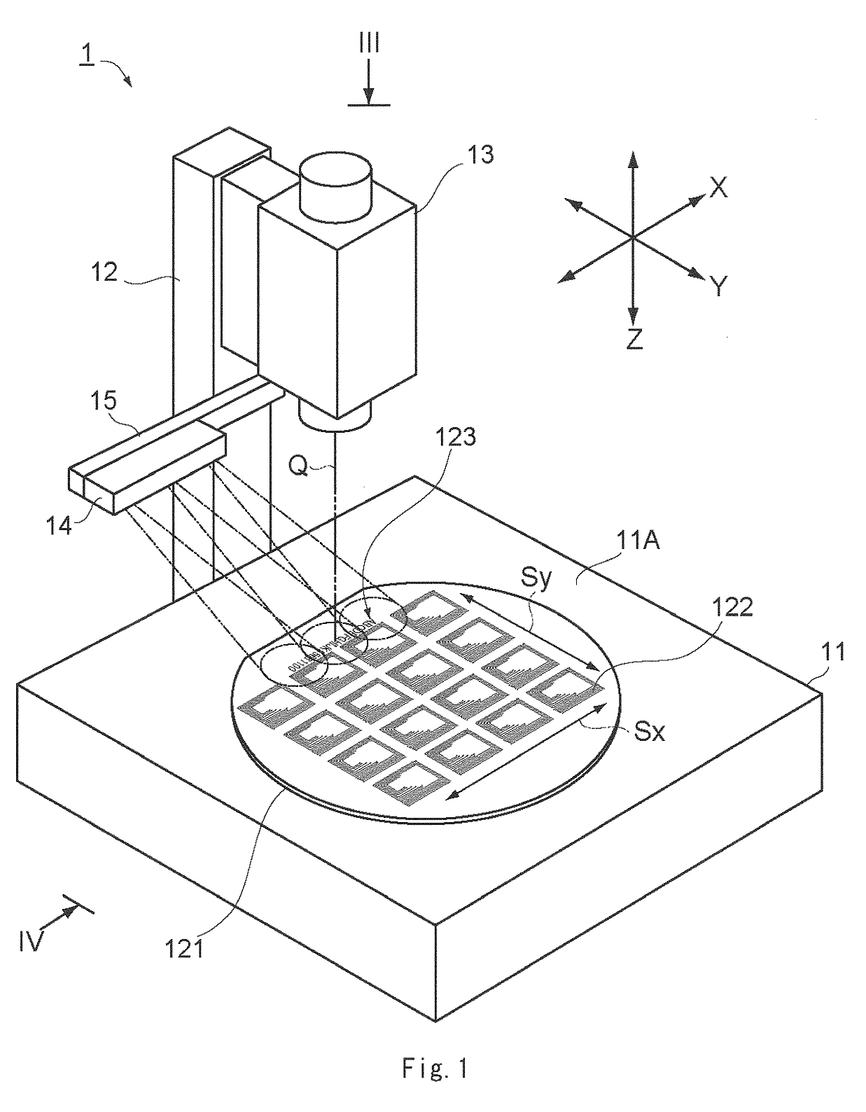

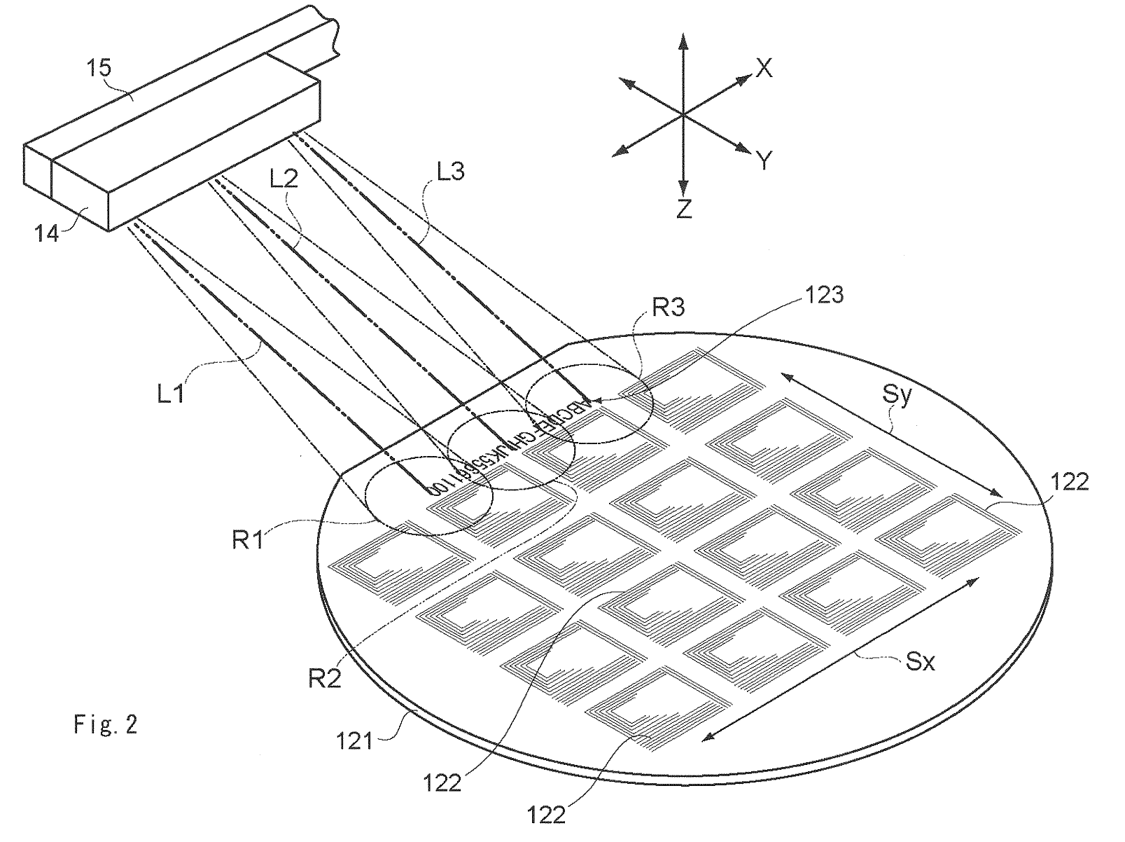

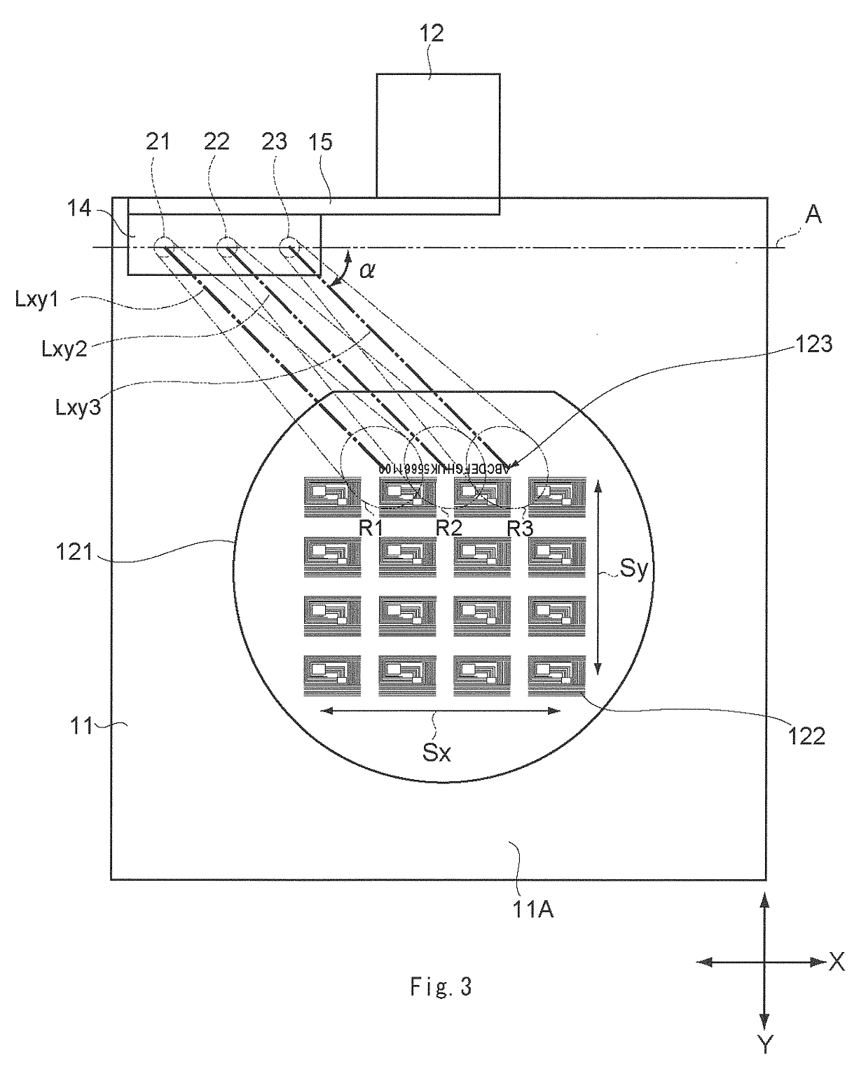

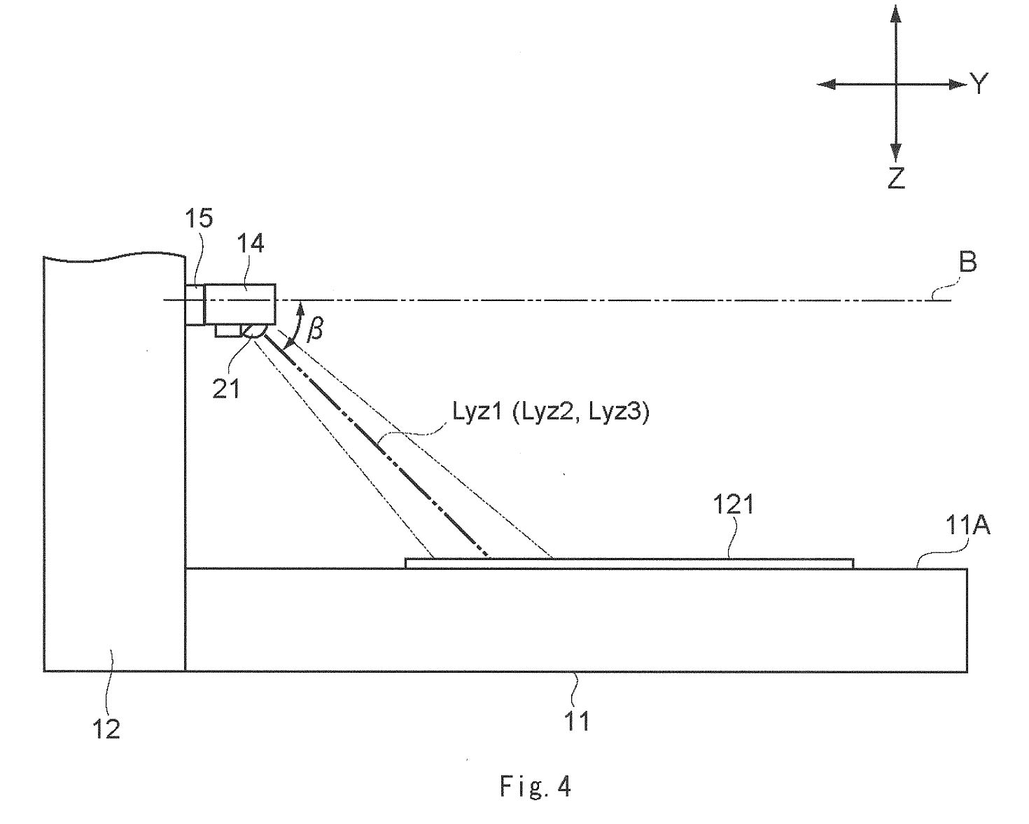

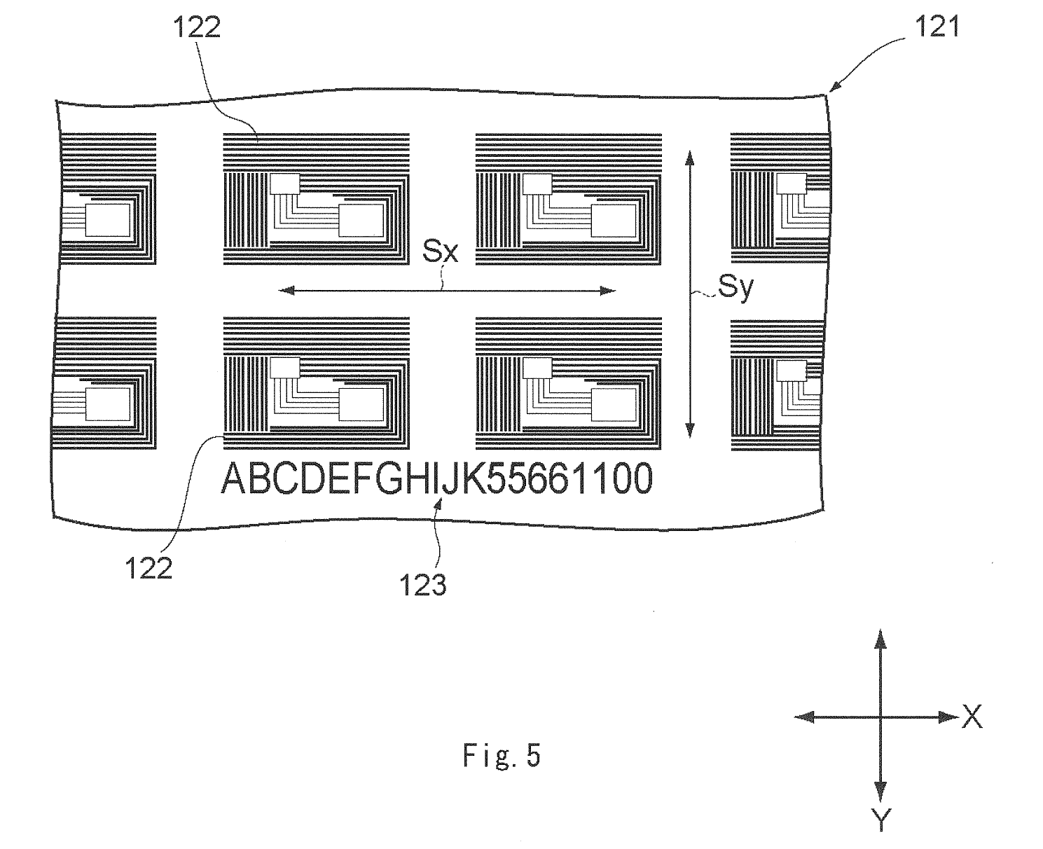

FIG. 1 shows an observation system including an illuminating device according to a first embodiment of the invention. FIG. 2 is an enlarged view showing an illuminating device and a wafer picked from the observation system shown in FIG. 1. FIG. 3 is a view when viewing the observation system shown in FIG. 1 from the top. FIG. 4 is a view when viewing observation system shown in FIG. 1 from the transverse direction. In FIG. 3 and FIG. 4, an observing device is omitted for convenience of explanation. FIG. 5 shows circuit interconnects formed on a wafer and ID marked on the surface of the wafer.

In FIG. 1, an observation system 1 is a system for reading ID (identification symbol) 123 marked on the surface of a semiconductor wafer 121. As shown in FIG. 5, the wafer 121 is formed with circuit interconnects 122. Most of circuit interconnects 122 extend to any of two directions Sx and Sy perpendicular to each other on a plane parallel to the surface of the wafer 121. ID (identification symbol) 123 is marked onto the surface of the wafer 121. The ID 123 is an inherent symbol for managing the wafer 121, for example. Each symbol (“A”, “B”, “C”, . . . “1”, “0”, “0”) forming the ID 123 is arranged in the direction parallel to the circuit interconnects 122. According to this embodiment, the foregoing each symbol is arranged in the Sx direction.

As seen from FIG. 1, the observation system 1 includes a base table 11, a support member 12, an observing device 13, an illuminating device 14 and a support arm 15. The base table 11 is a table for placing the wafer 121 given as an observation object. The upper surface of the base table 11 functions as a placement surface 11A given as an object placement plane for placing the wafer 121. The placement surface 11A is horizontally kept.

In this case, the foregoing observation system and wafer 121 exists in a three-dimensional space. The three-dimensional space is defined by X and Y axes, which are each parallel to the placement surface 11A and perpendicular to each other, and a X axis, which is perpendicular to X and Y axes (vertical to the placement surface 11A).

On the placement surface 11A, the wafer 121 is placed so that one extending direction Sx of the circuit interconnect 122 is parallel to the X axis while the other extending direction Sy thereof is parallel to the Y axis. The surface of the wafer 121 placed on the placement surface 11A of the base table 11 is parallel to the X-Y plane, that is, horizontal.

The support member 12 is a member for supporting the foregoing observing device 13 and illuminating device 14 above the base table 11. Further, the support member 12 has a proximal portion, which is fixed to the rear side of the base table 11, and a distal portion, which upwardly extends to the Z axis direction. The observing device 13 is a camera, for example, and shoots the ID 123 marked on the surface of the wafer 121 placed on the base table 11. Further, observing device 13 is supported downward so that an optical axis Q of a built-in camera lens is parallel with the Z axis.

The illuminating device 14 is a device for irradiating light (illumination light) to a portion on the surface of the wafer 121, on which the ID 123 is marked, in order to read the ID 123 marked thereon by the observing device 13. Further, the illuminating device 14 is arranged above the left corner on the rear side of the base table 11, and fixed to the support member 12 via a support arm 15.

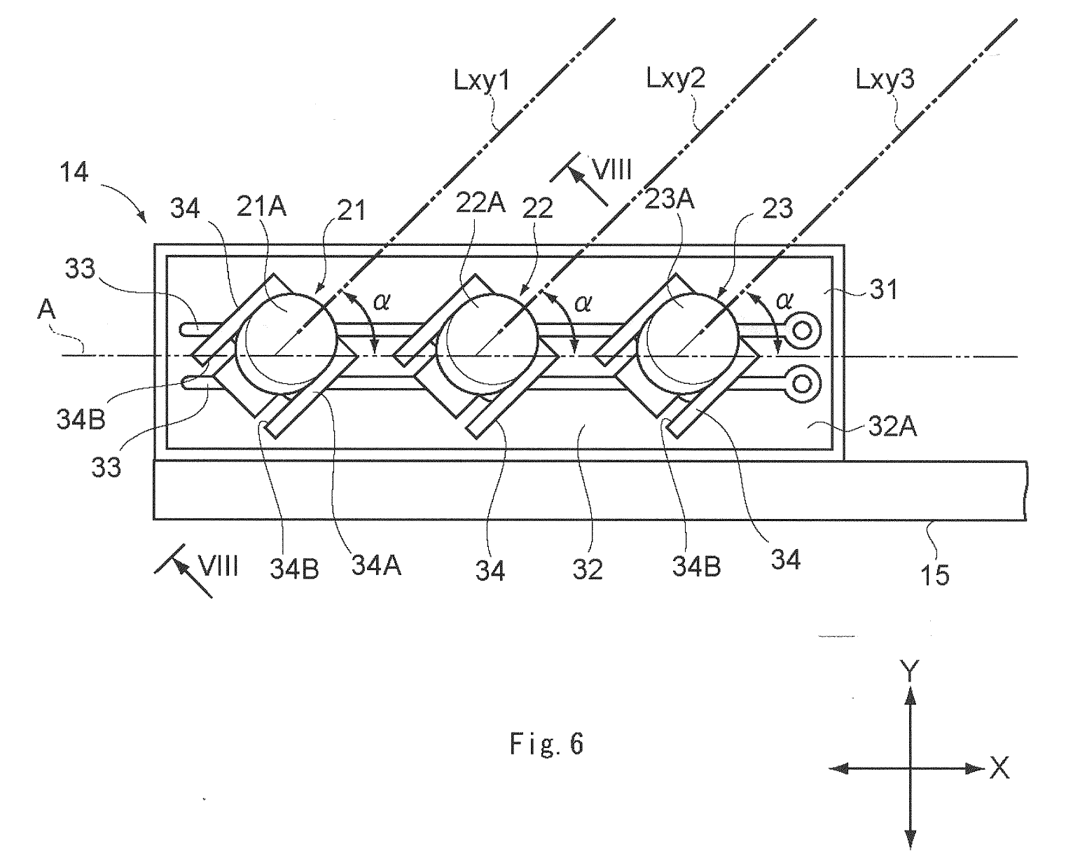

The illuminating device 14 has three light emitting diodes (LEDs) 21, 22 and 23 as described later (see FIG. 6). As illustrated in FIG. 3, lights emitting from these LEDs 21, 22 and 23 are irradiated toward the wafer 121 from opening portions formed at a lower portion of a casing 31. These lights travel downward in the oblique right from upward the left corner on the rear side of the base table 11 provided with the illuminating device 14 toward the ID 123 marked on the wafer 121 placed on the base table 11.

As depicted in FIG. 2, central axes of the orientation of lights emitted from LEDs 21, 22 and 23, that is, light emitting main axes L1, L2 and L3 thereof are parallel to each other.

As shown in FIG. 3, each angle α made by orthogonal projections Lxy1, Lxy2 and Lxy3 of light emitting main axes L1, L2 and L3 to the X-Y plane and the X axis is within a predetermined range from 15 to 75 degrees, for example, 45 degrees. In FIG. 3, a two-dotted chain line A is a straight line parallel with the X axis.

As seen from FIG. 4, each angle β made by orthogonal projections Lyz1, Lyz2 and Lyz3 of light emitting main axes L1, L2 and L3 to the Y-Z plane and the Y axis is within a predetermined range from 15 to 75 degrees, for example, 45 degrees. In FIG. 4, a two-dotted chain line B is a straight line parallel with the Y axis.

As illustrated in FIG. 2 and FIG. 3, irradiation ranges R1, R2 and R3 are formed on the surface of the wafer 121 by means of lights emitted from LEDs 21, 22 and 23. The foregoing irradiation ranges R1, R2 and R3 are an area on the surface of the wafer 121 irradiated by lights emitted from LEDs 21, 22 and 23. The whole of the ID 123 is included in an area merging these irradiation ranges R1, R2 and R3 together.

The support arm 15 is a member for supporting the illuminating device 14 at apposition separating from the base table 11 so that lights emitted from the device 14 is irradiated to the ID 123 marked on the wafer 121 placed on the placement surface 11A of the base table 11. The support arm 15 extends so that it is parallel to the X axis and vertical to the Y axis. Further, the support arm 15 has a proximal portion fixed to the support member 12, and a distal portion to which the illuminating device 14 is fixed. In this case, the mechanism for supporting the illuminating device 14 by the support arm 15 is not limited to above. For example, the illuminating device 14 may be directly supported to the base table 11 via the support arm 15.

In the observation system 1 having the foregoing structure, each angle made by orthogonal projections Lxy1, Lxy2 and Lxy3 of light emitting main axes L1, L2 and L3 of LEDs 21, 22 and 23 to the X-Y plane (i.e., surface of wafer 121) and the extending direction Sx of the circuit interconnects 122 on the wafer 121 is equal to an angle α shown in FIG. 3. Specifically, the angle α is within a predetermined range from 15 to 75 degrees; for example, 45 degrees. In this case, lights are irradiated to the circuit interconnects 122 extending to the direction Sx from LEDs 21, 22 and 23. Then, when observing the circuit interconnects 122 by the observing device 13, the circuit interconnects 122 are darkly reflected in the observing device 13.

Further, each angle made by orthogonal projections Lxy1, Lxy2 and Lxy3 of light emitting main axes L1, L2 and L3 of LEDs 21, 22 and 23 to the X-Y plane and the extending direction Sy of the circuit interconnects 122 on the wafer 121 is equal to an angle subtracting the angle α from 90 degrees, as seen from FIG. 3. Specifically, the angle α is within a predetermined range from 15 to 75 degrees; for example, 45 degrees. In this case, lights are irradiated to the circuit interconnects 122 extending to the direction Sy from LEDs 21, 22 and 23. Then, when observing the circuit interconnects 122 by the observing device 13, the circuit interconnects 122 are darkly reflected in the observing device 13.

Further, each angle made by orthogonal projections Lxy1, Lxy2 and Lxy3 of light emitting main axes L1, L2 and L3 of LEDs 21, 22 and 23 to the X-Y plane and the arrangement direction (=Sx) of each symbol forming the ID 123 marked on the surface of the wafer 121 is equal to an angle α shown in FIG. 3. Specifically, the angle α is within a predetermined range from 15 to 75 degrees; for example, 45 degrees. In this case, lights are irradiated to the ID 123 from LEDs 21, 22 and 23. Then, when observing the ID 123 by the observing device 13, the ID 123 is brightly reflected in the observing device 13.

Furthermore, an incident angle of lights emitted from the illuminating device 14 on the surface of the wafer 121 placed on the base table 11 is equal to an angle β shown in FIG. 4. Specifically, the angle β is within a predetermined range from 15 to 75 degrees; for example, 45 degrees. In this case, lights are irradiated to the ID 123 from LEDs 21, 22 and 23. Then, when observing the ID 123 by the observing device 13, the ID 123 is more brightly reflected in the observing device 13.

In other words, lights are irradiated to the circuit interconnects 122 and the ID 123 from LEDs 21, 22 and 23, and then, the observing device 13 observes these circuit interconnects 122 and ID 123. In this case, the circuit interconnects 122 are seen darkly in the observing device 13; conversely, the ID 123 is brightly seen therein. Namely, the ID 123 only is clearly observed in a state of being brightly reflected.

In the foregoing manner, the illuminating device 14 can brightly reflects the ID 123 marked between circuit interconnects 122 on the wafer 121. As described above, the illuminating device 14 has the following structure that LEDs 21, 22 and 23 are arranged linearly in parallel to the X axis and light emitting main axes L1, L2 and L3 are parallel to each other. Therefore, the illuminating device 14 can irradiate the whole of the ID 123 composed of symbol arranged in parallel to the X axis at a time; thus, this serves to clearly reflect the whole of the ID 123 at a time. Further, the illuminating device 14 has the following structure that irradiation ranges R1, R2 and R3 are limited to an area necessary and sufficient for irradiating the whole of the ID 123. Therefore, the illuminating device 14 does not irradiate an irradiation unnecessary area departing from the ID 123. As a result, this serves to improve irradiation efficiency, and to miniaturize and lighten the illuminating device 14, and to achieve a reduction of power consumption.

An examples of the structure of the illuminating device 14 included in the observing system 1 will be described in detail.

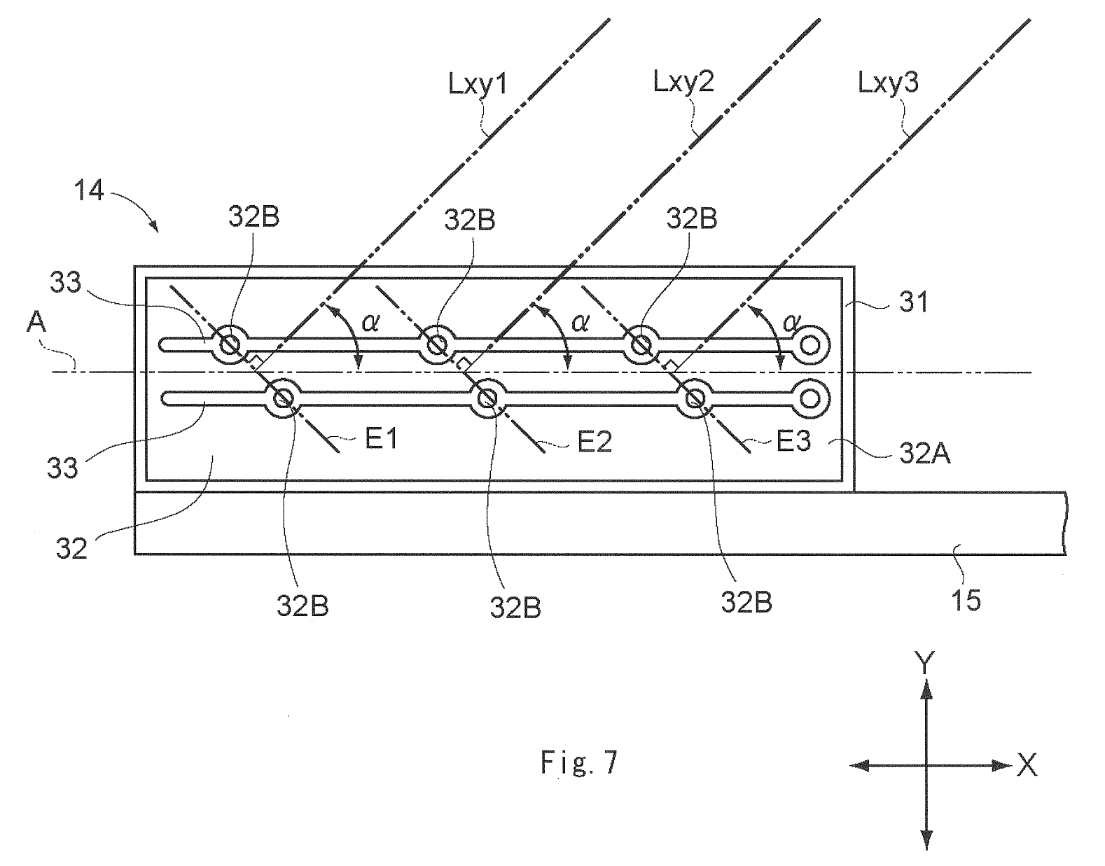

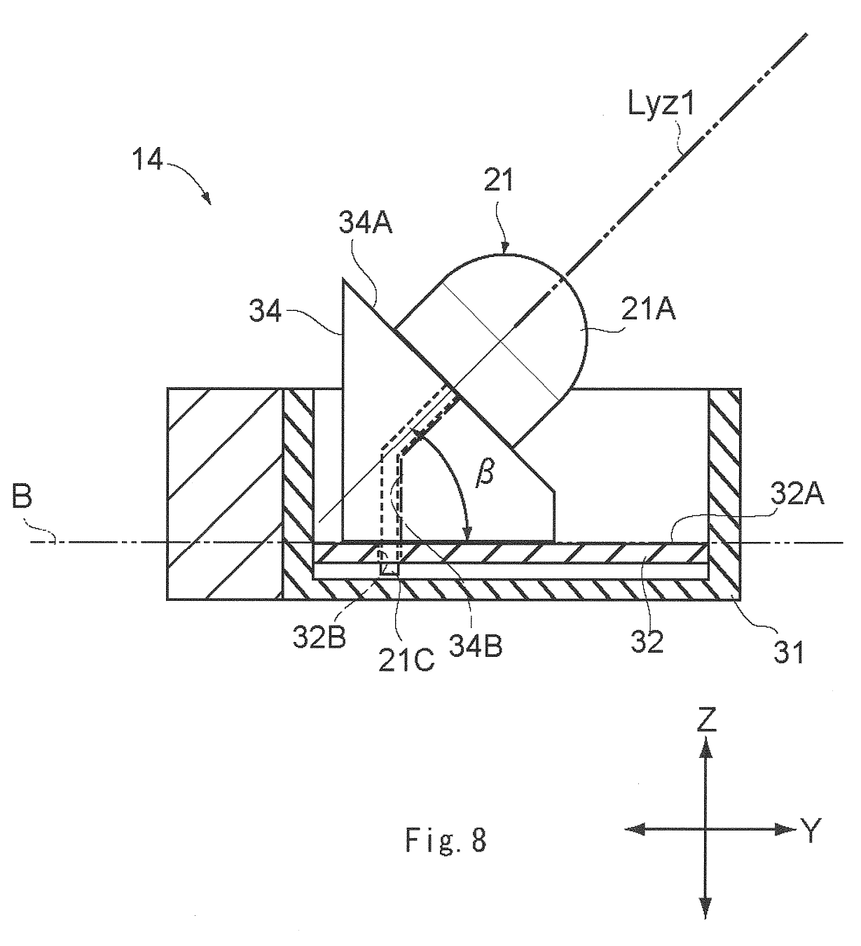

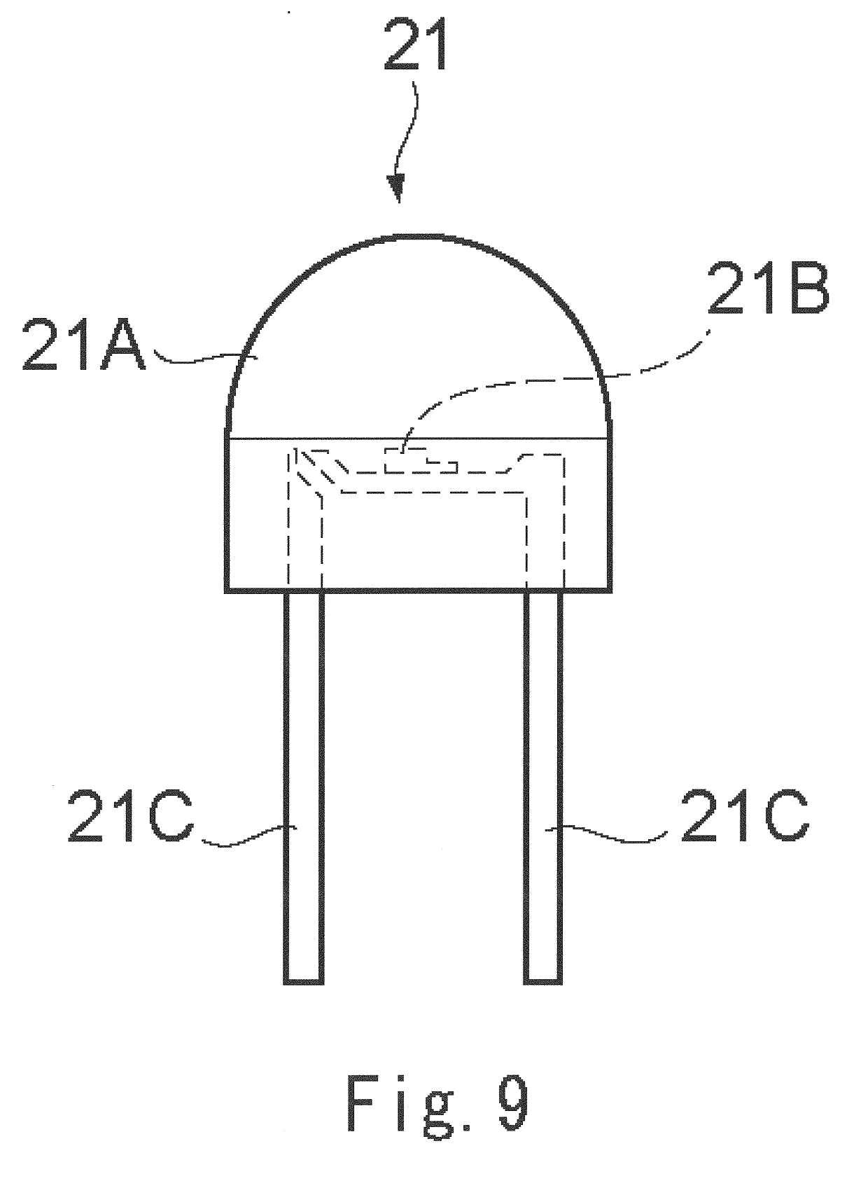

FIG. 6 shows a state when viewing the bottom of the illuminating device 14. FIG. 7 shows an illuminating device 14 of a state that LEDs 21, 22, 23 and positioning members 34 are detached from there. FIG. 8 is a cross-sectional view showing an illuminating device 14 when viewing it from the arrow VIII-VIII direction shown in FIG. 6. FIG. 9 shows an LED 21.

As shown in FIG. 6, the illuminating device 14 generally comprises a plurality of (e.g., three) LEDs 21, 22, 23, a casing 31, a substrate 32, and a plurality of (e.g., three) positioning members 34.

The casing 31 is formed into a box using a resin material, for example. The casing 31 has an opening at the lower side in a state of being attached to the support member 12 via the support arm 15 (see FIG. 1). Further, the casing 31 supports the substrate 32 from the backside of the substrate 32. In addition, the casing 31 is an example of a support member.

The substrate 32 is located in the casing 31 so that its backside faces the upper plate of the casing 31 and its surface faces the opening of the casing 31. The substrate 32 is fixed on the upper plate of the casing 31 at a position slightly separating from the upper plate via an attachment member (not shown). Further, the substrate 32 is formed of an insulating material such as glass, and the surface of the substrate 32 functions as an attachment surface 32A. As illustrated in FIG. 1, in a state that the illuminating device 14 is attached to the support member 12 via the support arm 15, the attachment surface 32A of the substrate 32 is located downward, and parallel to the X-Y plane.

As depicted in FIG. 7, the attachment surface 32A of the substrate 32 is formed with a pair of connection holes 32B through which a pair of leads 21C, 22C and 23C of LEDs 21, 22 and 23 are inserted, respectively. These connection holes 32B functions as a so-called via hole, which penetrates the substrate 32 and has an inner sidewall formed with a conductive film. Each opening of a pair of connection holes 32B positioned on the left side in FIG. 7 is arranged on a straight line E1 vertical to the orthogonal projection Lxy1 of the light emitting main axis L1 of LED 21 to the X-Y plane. Further, each opening of a pair of connection holes 32B positioned on the center in FIG. 7 is arranged on a straight line E2 vertical to the orthogonal projection Lxy2 of the light emitting main axis L2 of LED 22 to the X-Y plane. Further, each opening of a pair of connection holes 32B positioned on the right side in FIG. 7 is arranged on a straight line E3 vertical to the orthogonal projection Lxy3 of the light emitting main axis L3 of LED 23 to the X-Y plane.

Further, the attachment surface 32A of the substrate 32 is provided with a pair of conductive lines 33, which are parallel to each other. Each conductive line 33 is formed of a conductive material; for example, a printed pattern formed on the attachment surface 32A. Each conductive line 33 is formed with a hole, which communicate with the connection hole 32B, at a portion positioning on each connection hole 32B. The circumferential portion of the hole is formed with a land.

In FIG. 6, the positioning members 32 are members for determining the direction of LEDs 21, 22 and 23, and provided on the attachment surface 32A of the substrate 32. Plural positioning members 34 are provided plural in accordance with the number of LEDs 21, 22 and 23. Each positioning member 34 is formed like a square pillar using an insulating material such as a resin. As illustrated in FIG. 8, each positioning member 34 has a distal surface 34A. The tilt direction and angle of the distal surface 34A are set to be vertical to the light emitting main axis L1 (L2, L3).

Further, each positioning member 34 is formed with a pair of trenches 34B for inserting the lead 21C (22C, 23C) of LED 21 (22, 23). As seen from FIG. 8, the bottom inner surface (right inner surface in FIG. 8) of each trench 34B bents on the halfway.

LEDs 21, 22 and 23 are light emitting members, which functions as a light source of the illuminating device 14 and irradiates the ID 123 marked on a wafer placed on the base table 11. As illustrated in FIG. 6, these LEDs are arranged linearly on the attachment surface 32A of the substrate 32. In a state that the illuminating device 14 is attached to the support member 12 via the support arm 15 as shown in FIG. 1, the arrangement direction of LEDs 21, 22 and 23 is parallel to the X axis.

As depicted in FIG. 9, each LED 21 (22, 23) includes an LED body 21A (22A, 23A), an LED chip 21B (22B, 23B) and a pair of leads 21C (22C, 23C). Specifically, the LED chip 21B (22B, 23B) is located in the LED body 21A (22A, 23A). The LED chip 21B (22B, 23B) projects from a proximal side of the LED body 21B (22B, 23B), and applies a voltage.

As seen from FIG. 8, the LED body 21A (22A, 23A) is placed on the distal surface 34A of the positioning member 34 so that the surface on the proximal side of the LED body 21A (22A, 23A) is abutted against the distal surface 34A. Each lead 21C (22C, 23C) is inserted in the trench 34B of the positioning member 34 ranging between its proximal portion to its halfway portion, and bends along a bent shape of the bottom inner surface of the trench 34B. Further, a distal portion of each lead 21C (22C, 23C) is inserted in the connection hole 32 of the substrate 32, and electrically connected and fixed to the conductive line 33 by means such as soldering.

In this manner, a pair of lead 21C (22C, 23C) is mounted to the trench 34B of the positioning member 34 and to the connection hole 32B of the substrate 32. The surface on the proximal side of the LED body 21A (22A, 23A) is abutted against the distal surface 34A of the positioning member 34. In the manner described above, the light emitting main axis of LED 21 (22, 23) is fixed to L1 (L2, L3). Specifically, in the illuminating device 14 according to this embodiment, it is possible to easily achieve high-precise setting of light emitting main axes L1, L2 and L3 of lights (illumination lights) emitted from the illuminating device 14.

### Second Embodiment

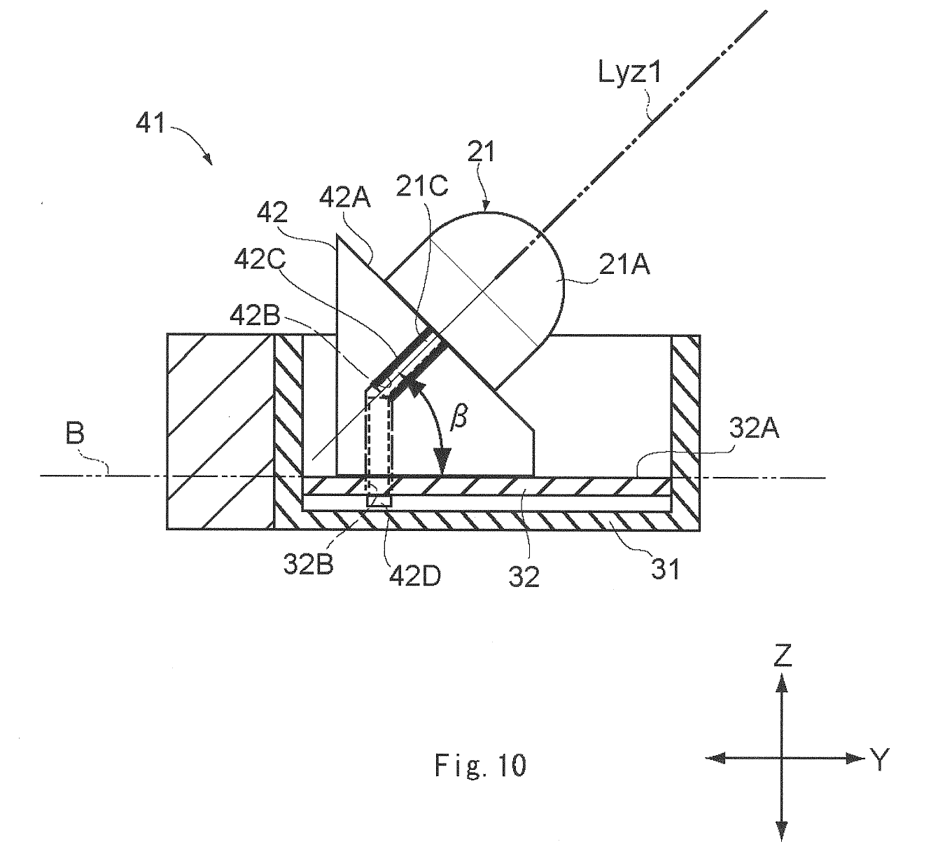

FIG. 10 shows an illuminating device according to a second embodiment of the present invention. The illuminating device 14 according to the foregoing first embodiment has the structure that the LED body 21A (22A, 23A) of LEDs 21 (22, 23) is placed on each positioning member 34. Namely, each positioning member 34 functions as a so-called spacer. Compared with the foregoing structure, an illuminating device 41 according to the second embodiment has a structure that each positioning member 42 functions as a socket.

Specifically, as shown in FIG. 10, each positioning member 42 in the illuminating device 41 is formed like a square pillar, and has a tilted distal surface 42A, as well as the positioning member 34 of the first embodiment. However, each positioning member 42 differs from the positioning member 34 of the first embodiment in that the member 42 has a pair of through holes 42B in place of a pair of trenches.

Each through hole 42B extends from a distal surface 42A of the positioning member 42 toward a proximal surface abutting against an attachment surface 32A of a substrate 32, and bends on the halfway. Further, the through hole 42B extends to a direction vertical to the distal surface 42A ranging between an opening portion on the distal surface 42A and a bent position. Further, the through hole 42B extends to a direction vertical to the proximal surface ranging between the bent position and an opening portion on the proximal surface. Each through hole 42B ranging between an opening portion on the distal surface 42A and the bent position functions as a lead insertion hole. The inner wall of the hole 42B is provided with an electrode 42C. Moreover, each through hole 42B ranging between the bent position and the opening portion on the proximal surface functions as a connector pin insertion hole. A connector pin 42D is inserted in the connector pin insertion hole. The connector pin 42D has one side fixed by a boding agent in the connector pin insertion hole, and has the other side projecting from the proximal surface of the positioning surface. Further, the connector pin 42D is electrically connected to the electrode 42C.

A pair of connector pins 42D of each positioning member 42 is inserted in a pair of connection hole 32B of the substrate 32, and further, electrically connected and fixed to a pair of conductive line 33. Therefore, each positioning member 42 is fixed on the attachment surface 32A of the substrate 32. On the other hand, a pair of leads 21C (22C, 23C) of LEDs 21 (22, 23) is inserted in a pair of electrode 42C provided on the distal side of each positioning member. Therefore, each electrode 42C is electrically connected to each lead 21C (22C, 23C). In this case, each lead 21C (22C, 23C) may be removable (pressed and fitted) with respect to each electrode 42C, or may be fixed by means such as soldering.

The illuminating device 41 according to the second embodiment has the foregoing structure; therefore, it is possible to easily remove LEDs 21, 22 and 23 with respect to the positioning member 42. This serves to simply carry out attachment, detachment and replacement of LEDs 21, 22 and 23.

### Third Embodiment

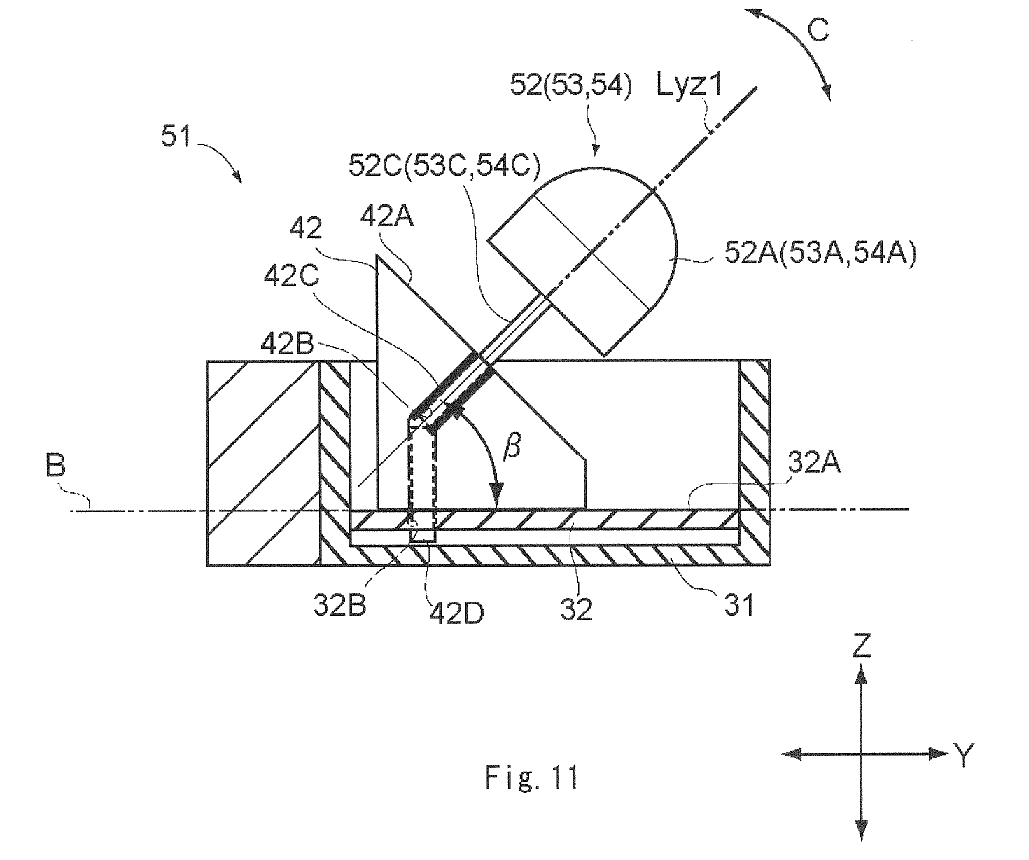

FIG. 11 shows an illuminating device according to a third embodiment of the present invention. As illustrated in FIG. 11, an illuminating device 51 according to the third embodiment has a structure that a pair of leads 52 (53C, 54C) of each LED 52 (53, 54) is longer compared with the illuminating device of the second embodiment. For this reason, a part of the lead 52C (53C, 54C) projects from a through hole 42B of a positioning member 42. Further, an LED body 52A (53A, 54A) is separated from a distal surface 42A of the positioning member 42.

The illuminating device according to the third embodiment of the present invention has the foregoing structure. Therefore, in a pair of leads 52C, 53C and 54C of each LED 52, 53 and 54, a portion projecting from the through hole 42B of the positioning member 42 is bent, so that an angle β can be arbitrarily changed. This serves to change the direction of LEDs 52, 53 and 54, and to easily and quickly adjust light emitting main axes L1, L2 and L3 of LEDs 52, 53 and 54 (orthogonal projections Lyx1, Lyz2 and Lyz3 to the Y-Z plane).

In each pair of connection holes 32B of the substrate 32, a straight line connecting a pair of connection holes 32B is vertical to the orthogonal projection Lxy1 of the light emitting main axis L1 (L2, L3) of LED 52 (53, 53) to the X-Y plane (see FIG. 7). Moreover, a straight line connecting openings of the distal surfaces 42A of a pair of through holes 42B of each positioning member 42 is vertical to the orthogonal projection Lxy1 of the light emitting main axis L1 (L2, L3) of LED 52 (53, 54) to the X-Y plane. A pair of leads 52C (53C, 54C) of each LED 52 (53, 54) projecting from a pair of through holes 42B of each positioning member 42 projects in parallel to the light emitting main axis L1 (L2, L3). As a result, the lead 52C (53C, 54C) can be easily bent to a direction shown by an arrow C of FIG. 11 without unreasonably giving a force.

Therefore, leads 52C, 53C and 54C of LEDs 52, 53 and 54 are bent in accordance with the shape and position of an observation object placed on the placement surface 11A of the base table 11 to change an angle β. As a result, light emitting main axes L1, L2 and L3 of LEDs 52, 53 and 54 can be adjusted. In addition, the foregoing adjustment can be simply made there during observation. For example, even if a position of the ID 123 marked on the surface of the wafer 121 is changed; the irradiation range of LEDs 52, 53 and 54 can be simply changed in accordance with the foregoing change.

### Fourth Embodiment

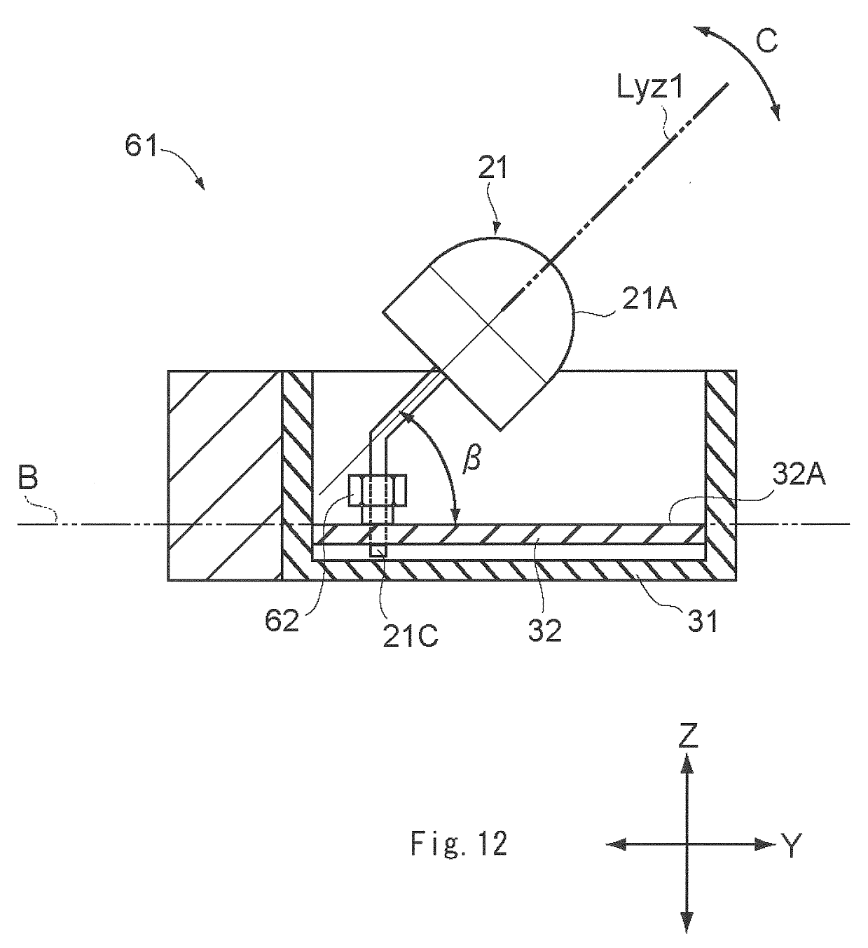

FIG. 12 shows an illuminating device according to a fourth embodiment of the present invention. As seen from FIG. 12, in an illuminating device 61, a structure may be employed such that the distal portion only of leads 21C (22C, 23C) of LED 21 (22, 23) is supported by each positioning member 62. According to the foregoing structure, leads 52C, 53C and 54C of LEDs 52, 53 and 54 are bent, and thereby, an angle β can be easily changed as well as the third embodiment. Therefore, light emitting main axes L1, L2 and L3 can be simply adjusted.

### Fifth Embodiment

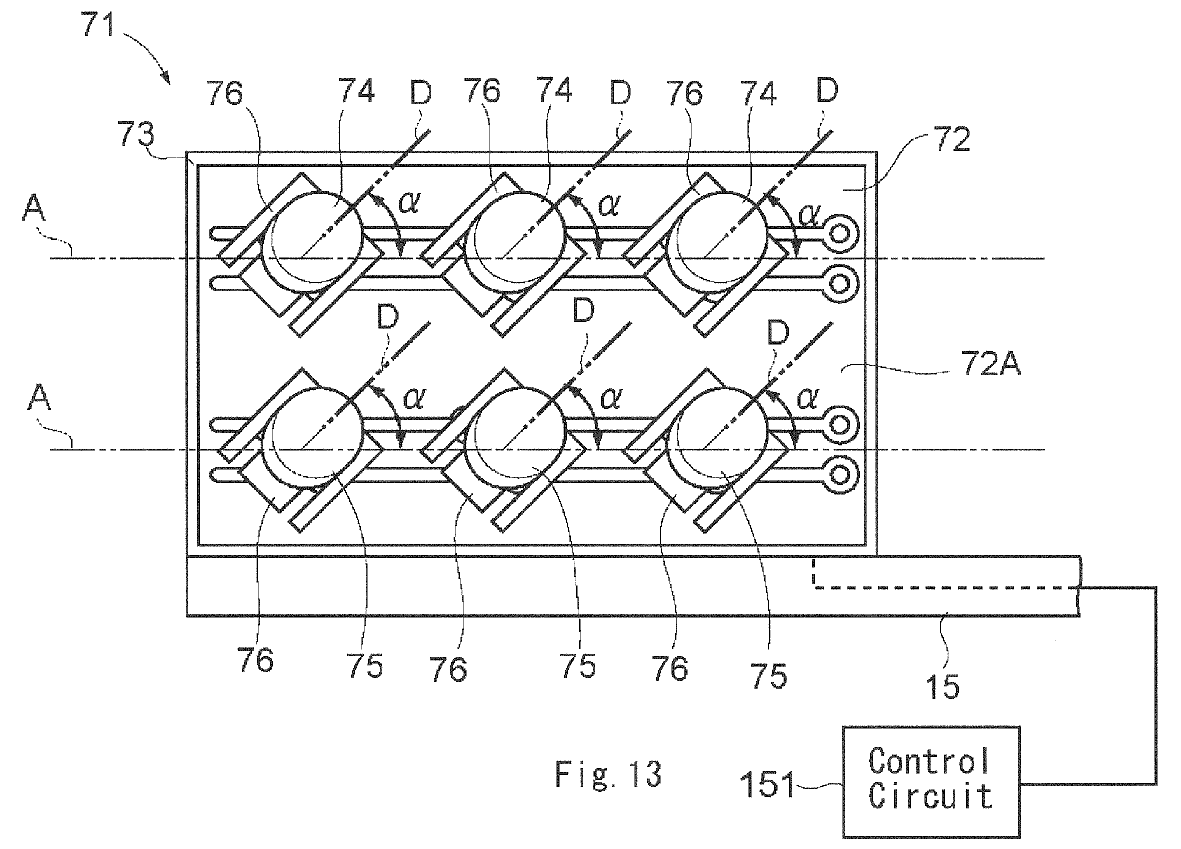

FIG. 13 shows an illuminating device according to a fifth embodiment of the present invention. As shown in FIG. 13, LEDs may be arranged like a plurality of columns. Specifically, an illuminating device 71 according to the fifth embodiment includes a substrate 72, a casing 73, a plurality of first-group LEDs 74, a plurality of second-group LEDs 75 and a plurality of positioning members 76. More specifically, the casing 73 supports the substrate 72 from the backside of the substrate 72. First- and second-group LEDs 74 and 75 are linearly arranged on an attachment surface 72A of the substrate 72. The positioning members 76 are used for determining the direction of LEDs 74 and 75. In this case, first- and second-group LEDs 74 and 75 are arranged in two lines on the attachment surface 72A so that their arrangement directions are parallel to each other.

The direction of each LED 74 is set to satisfy the following condition. According to the condition, light emitting main axes of the first-group LEDs 74 are parallel to each other. Further, an angle α made by an orthogonal projection D of the light emitting main axis of each LED 74 to the X-Y plane and the X axis is set within a predetermined range from 15 to 75 degrees; for example, 45 degrees. Furthermore, an angle β (not shown in FIG. 13) made by an orthogonal projection of the light emitting main axis of each LED 74 to the Y-Z plane and the Y axis is set within a predetermined range from 0 to 75 degrees; for example, 45 degrees. The direction of second-group LEDs 75 is set as well as the direction of first-group LEDs 74.

The arrangement of a plurality of connection holes formed on the substrate 72 for connecting LEDs 74 and 75, electrical connection of LEDs 74 and 75 and the structure of each positioning member 76 are the same as the illuminating device described in the first embodiment. Specifically, the foregoing arrangement, connection and structure are the same as the arrangement of connection holes 32B, the electrical connection of LEDs 21, 22 and 23 via the conductive line 33 and the structure of the positioning member 34, respectively.

The illuminating device 71 according to the fifth embodiment of the present invention has the foregoing structure. Therefore, the illuminating device 71 is able to expand the irradiation range in the Y-axis direction on the placement surface 11A of the base table 11. As a result, the whole of two or three lines of IDs marked on the wafer 121 can be irradiated at a time.

In addition, the illuminating device 71 may be provided with a control circuit 151, which functions as control means for turning on LEDs 74 and 75 every group. LEDs 74 and 75 are turned on very group by the foregoing control circuit 151. For example, this serves to change the irradiation range in accordance with an observation object and a shooting object.

### Sixth Embodiment

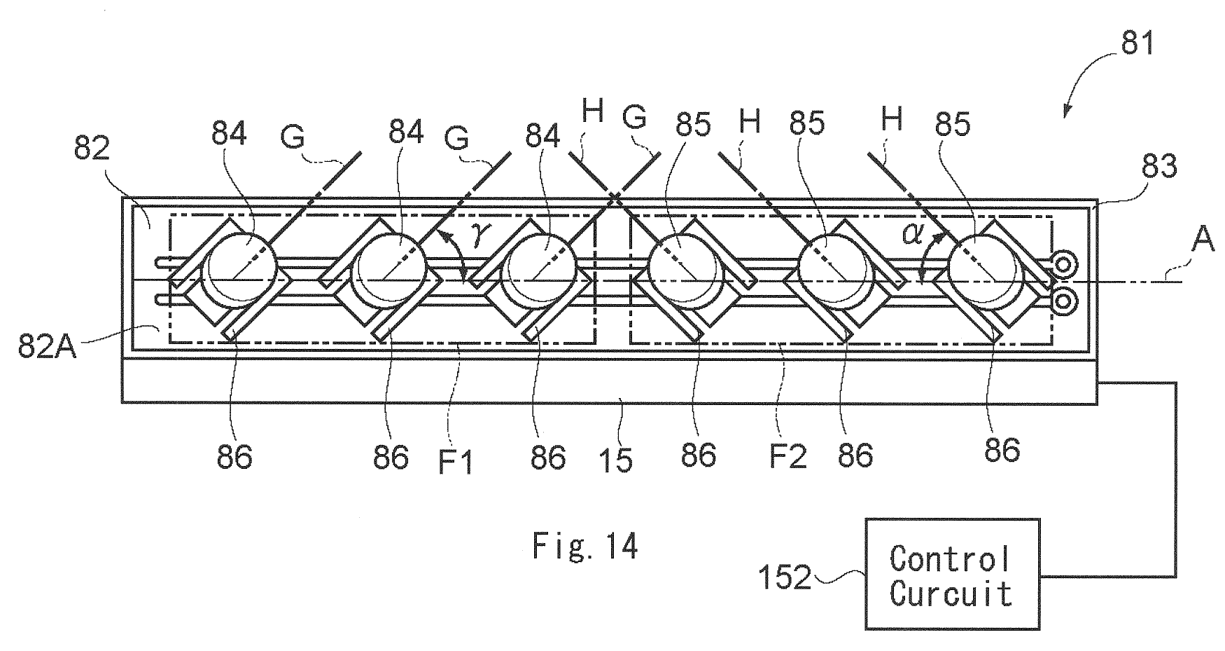

FIG. 14 shows an illuminating device according to a sixth embodiment of the present invention. As illustrated in FIG. 14, an illuminating device 81 according to the sixth embodiment includes a substrate 82, a casing 83, a plurality of first-group LEDs 84, a plurality of second-group LEDs 85 and a plurality of positioning members 86. Specifically, the casing 83 supports the substrate 82 from the backside of the substrate 82. The first-group LEDs 84 are linearly arranged in a first area F1 formed on an attachment surface 82A of the substrate 82. The second-group LEDs 85 are linearly arranged in a second area F2 formed on an attachment surface 82A of the substrate 82. The positioning members 86 are used for determining the direction of LEDs 84 and 85. The foregoing first- and second-group LEDs 84 and 85 are arranged in line on the attachment surface 82A so that their arrangement directions coincide with each other.

The direction of each LED 84 is set to satisfy the following condition. According to the condition, light emitting main axes of the first-group LEDs 84 are parallel to each other. Further, an angle α made by an orthogonal projection G of the light emitting main axis of each LED 84 to the X-Y plane and the X axis is set within a predetermined range from 15 to 75 degrees; for example, 45 degrees. Furthermore, an angle β (not shown in FIG. 14) made by an orthogonal projection of the light emitting main axis of each LED 84 to the Y-Z plane and the Y axis is set within a predetermined range from 0 to 75 degrees; for example, 45 degrees.

Moreover, the direction of each LED 85 is set to satisfy the following condition. According to the condition, light emitting main axes of the second-group LEDs 85 are parallel to each other. Further, an angle γ made by an orthogonal projection H of the light emitting main axis of each LED 85 to the X-Y plane and the X axis is set within a predetermined range from 15 to 75 degrees (i.e., 105 to 165 degrees); for example, 45 (135) degrees. Further, an angle β (not shown in FIG. 14) made by an orthogonal projection of the light emitting main axis of each LED 85 to the Y-Z plane and the Y axis is set within a predetermined range from 0 to 75 degrees; for example, 45 degrees. Furthermore, the light emitting main axis of each LED 85 and the light emitting main axis of each LED 85 cross each other at right angles.

The illuminating device 81 according to the sixth embodiment of the present invention has the foregoing structure. Therefore, the illuminating device 81 is able to expand the irradiation range in the X-axis direction on the placement surface 11A of the base table 11. For example, even if ID marked on the wafer 121 is long in the Sx direction, the whole of ID can be irradiated at a time.

In addition, the illuminating device 81 may be provided with a control circuit 152, which functions as control means for turning on LEDs 84 and 85 every group.

### Seventh Embodiment

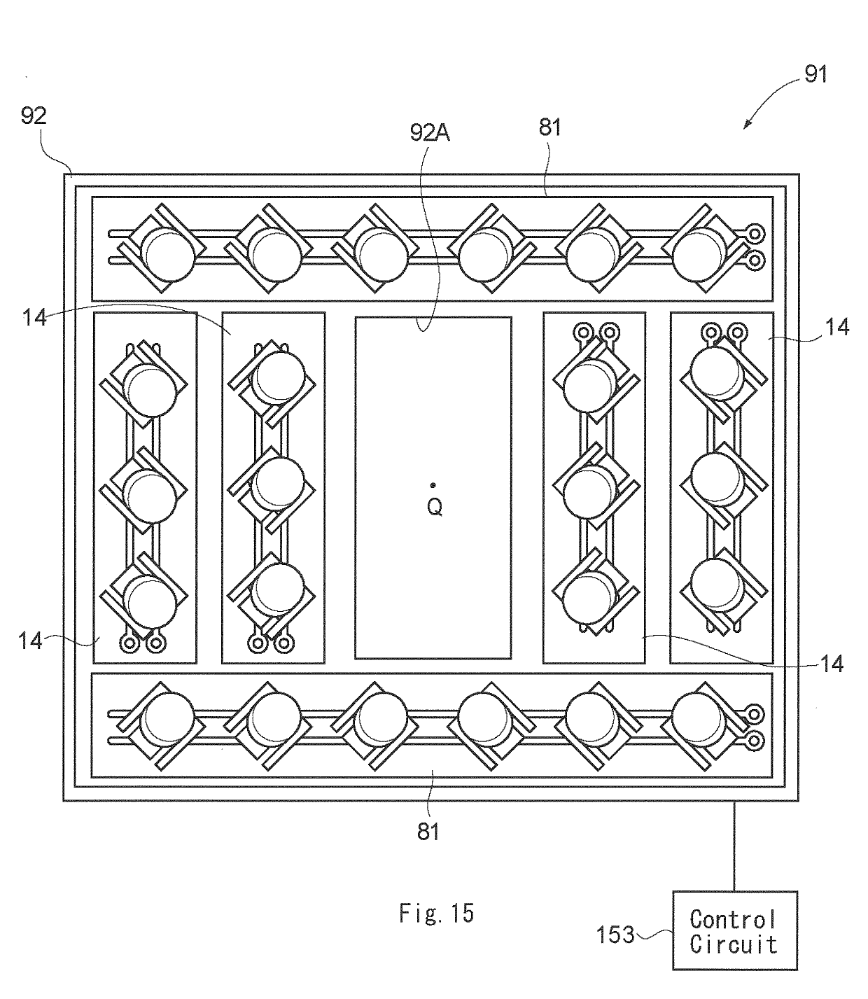

FIG. 15 shows an illuminating system according to a seventh embodiment of the present invention. An illuminating system 91 shown in FIG. 15 comprises four illuminating devices 14 of the first embodiment, two illuminating devices 81 of the sixth embodiment and a casing 92. Specifically, these illuminating devices 14 and 81 are arranged around an optical axis Q of an observing device oriented toward an observation object. The casing 92 is provided in place of casings of illuminating devices 14 and 81, and configured to integrate these casings. The center portion of the casing 92 is formed with an opening 92A. An optical axis Q of an observing device is set in the casing 92 so that the observing device can observe an observation object via the opening 92A.

The illuminating system 91 according to the seventh embodiment of the present invention has the forgoing structure. Therefore, the irradiation range is expanded in X-axis and Y-axis directions on the placement surface 11A of the base table 11. For example, this serves to irradiate a plurality of IDs marked on some portions of the surface of wafer at a time. Moreover, the illuminating system 91 may be provided with a control circuit 153, which functions as control means for turning on LEDs every illuminating device.

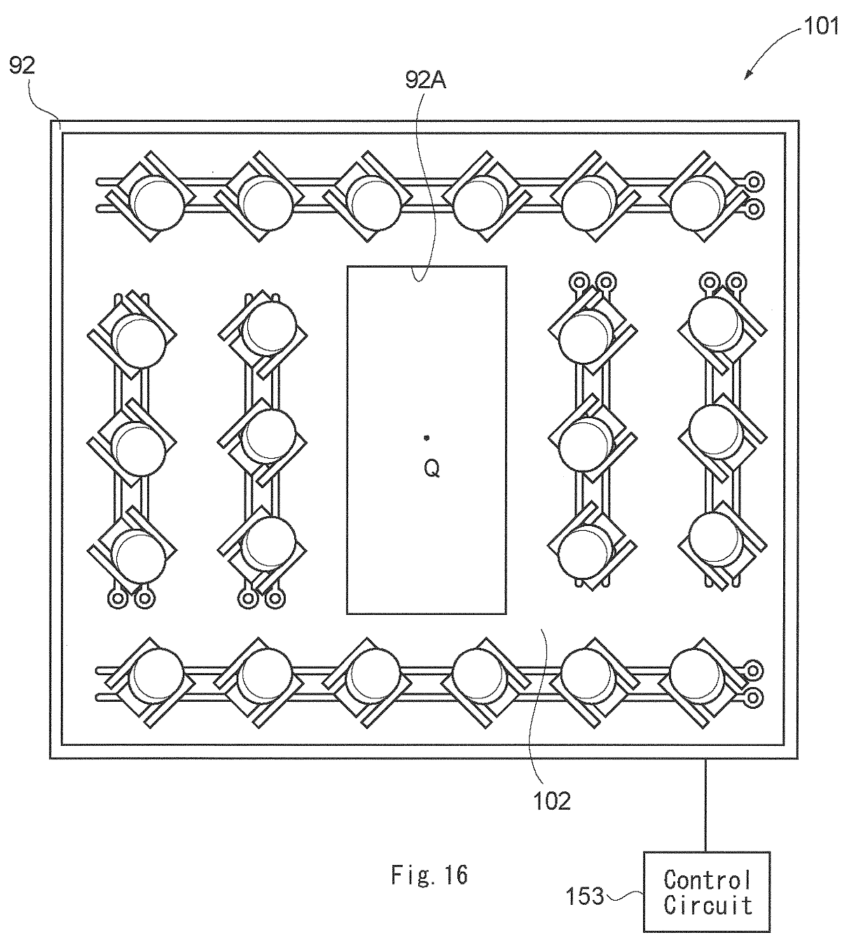

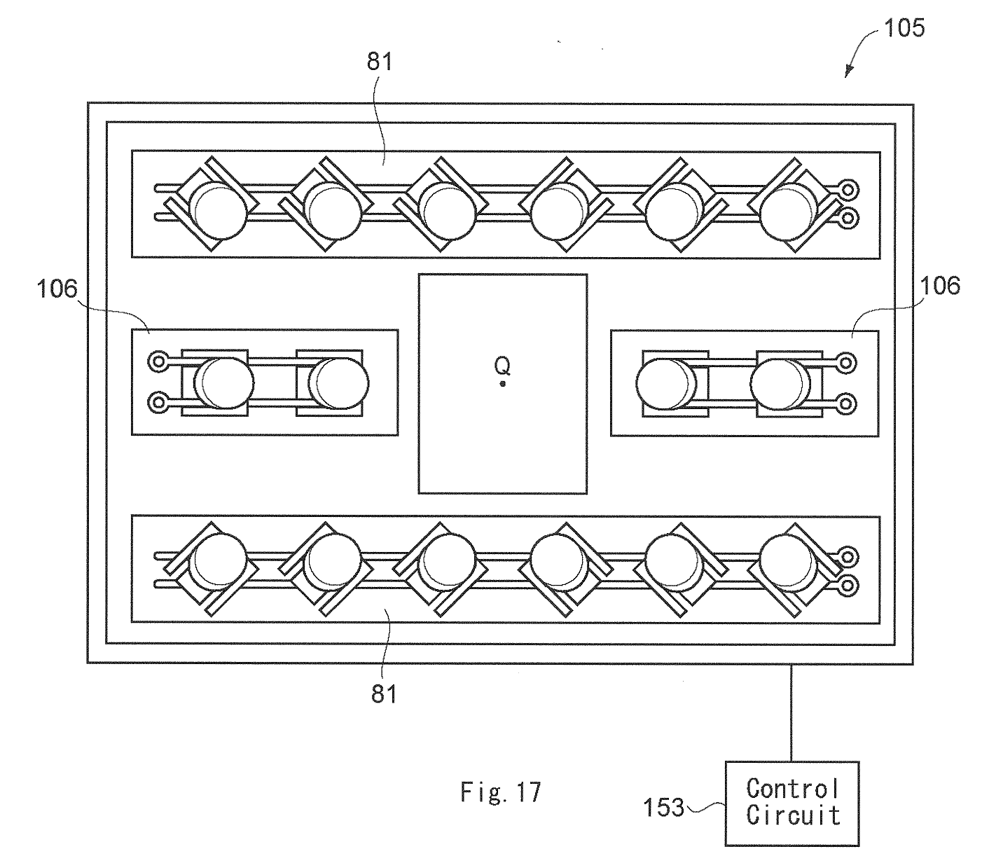

FIG. 16 and FIG. 17 show modification examples of the illuminating system according to the seventh embodiment of the present invention. An illuminating system 101 shown in FIG. 16 comprises four illuminating devices 14 of the first embodiment, two illuminating devices 81 of the sixth embodiment and a casing 92. Specifically, these illuminating devices 14 and 81 are arranged around an optical axis Q of an observing device oriented toward an observation object. The casing 92 is formed to integrate casings of illuminating devices 14 and 81 in place of them, and configured to have an opening 92A on the center. Further, the illuminating system may be provided with a substrate 102, which is configured to integrate substrates of illuminating devices 14 and 81 in place of them and has an opening on the center.

Moreover, an illuminating system 105 shown in FIG. 17 has the following structure. According to the structure, another illuminating device 106 and the illuminating device of the foregoing embodiment of the present invention (e.g., illuminating device 81 of the sixth embodiment) may be combined. The illuminating device 106 includes LEDs arranged so that orthogonal projections of light emitting main axes to the X-Y plane are parallel to the X axis.

### Eighth Embodiment

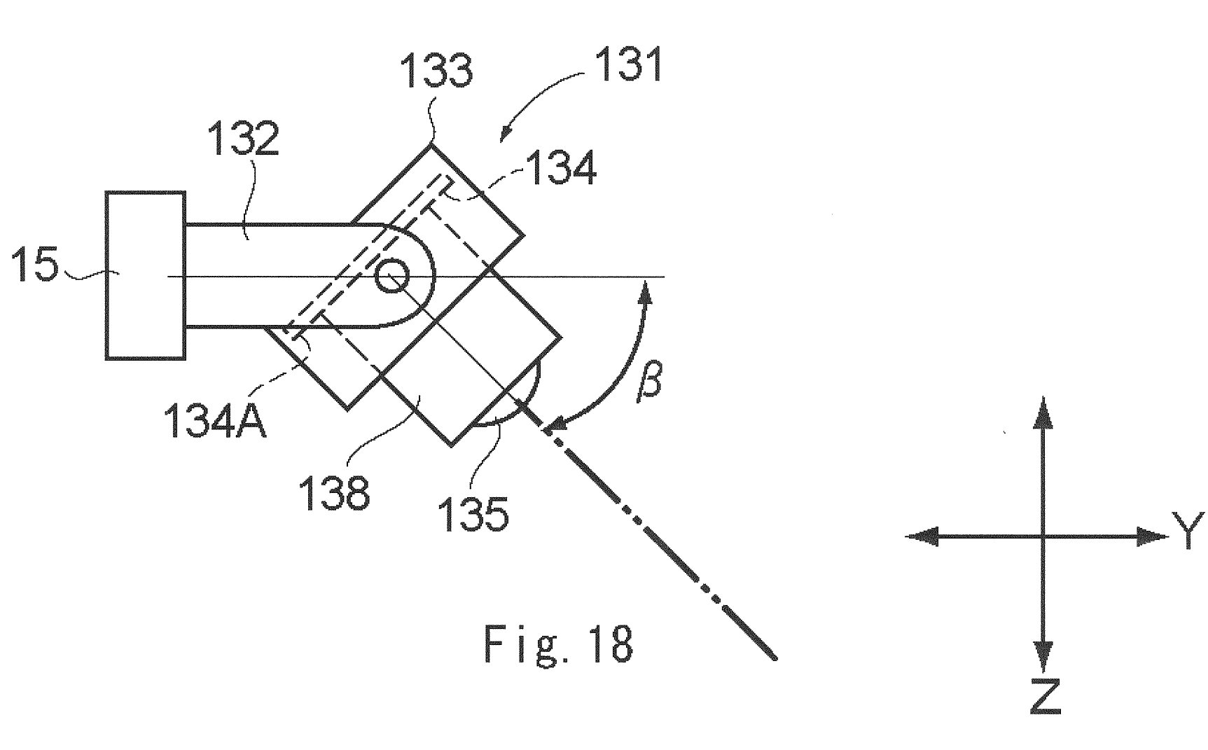

FIGS. 18 to 20 show an illuminating system according to an eighth embodiment of the present invention. The illuminating system includes an illuminating device and a support member for rotatably supporting the illuminating device.

According to the foregoing first embodiment, in the illuminating device 14, the substrate 32 used for attaching LEDs 21, 22 and 23 is arranged so that the attachment surface 32A is parallel to the X-Y plane (i.e., placement surface 11A). Further, in a state that the substrate 32 is fixed in the foregoing arrangement, LEDs 21, 22 and 23 are attached in a state of being tilted, and thereby setting each angle of light emitting main axes L1, L2 and L3 of LEDs 21, 22 and 23. Compared with the illuminating device 14, according to the eighth embodiment of the present invention, an illuminating device 131 has the following structure. Specifically, as shown in FIG. 18, the illuminating device 131 is rotatably supported to a support arm 15 via a support member 132; therefore, it is rotatable in an arrow shown in FIG. 18. As described above, the illuminating device 131 is rotated, and thereby, it is possible to tilt a substrate 134 supported in a casing 133 of the illuminating device 131 with respect to the X-Y plane. Therefore, the directions of a plurality of LEDs 135, 136 and 137 attached on an attachment surface 134A of the substrate 134 are changed. This serves to set an angle β made by orthogonal projections of light emitting main axes of these LEDs 135, 136 and 137 to the Y-Z plane and the Y axis.

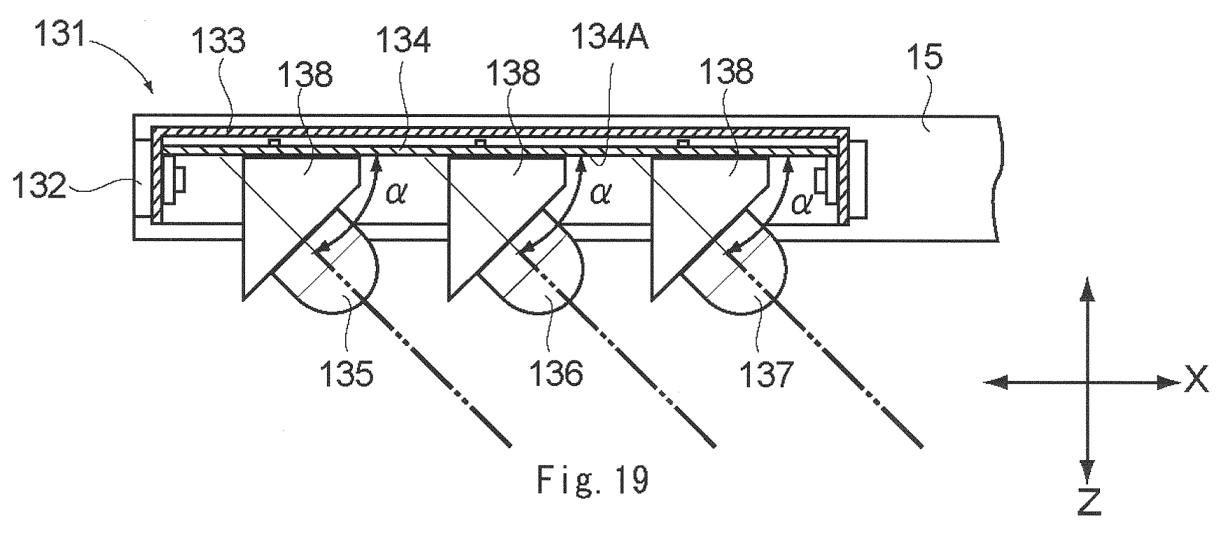

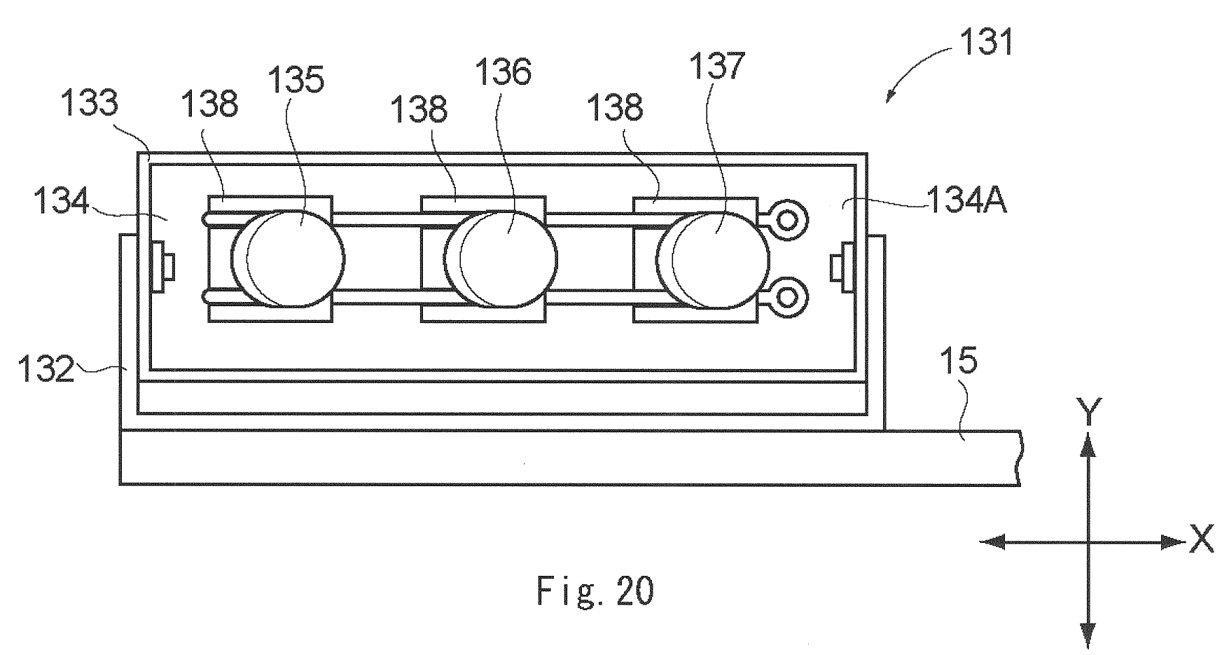

Specifically, as illustrated in FIG. 19 and FIG. 20, in a state that the attachment surface 134A of the substrate 134 is parallel to the X-Y plane, an angle α made by each light emitting main axis of these LEDs 135, 136 and 137 and the Y axis is set to 15 to 75 degrees by a positioning member 138; for example, 45 degrees. Moreover, an angle β made by each orthogonal projection of light emitting main axes of these LEDs 135, 136 and 137 to the Y-Z plane and the Y axis is 90 degrees.

As depicted in FIG. 18, the illuminating device 131 is rotated, and then, the attachment surface 134A of the substrate 134 is tilted to 15 to 90 degrees, for example, 45 degrees with respect to the X-Y plane. The foregoing movement is carried out, and thereby, an angle β made by orthogonal projections of light emitting main axes of these LEDs 135, 136 and 137 to the Y-Z plane and the Y axis is set to 0 to 75 degrees; for example, 45 degrees.

As described above, the illuminating device 131 is rotated, and thereafter, the casing 133 is fixed to the support member 132 by fastening a nut. By doing so, an angle β made by each orthogonal projection of light emitting main axes of these LEDs 135, 136 and 137 to the Y-Z plane and the Y axis can be kept to an predetermined angle.

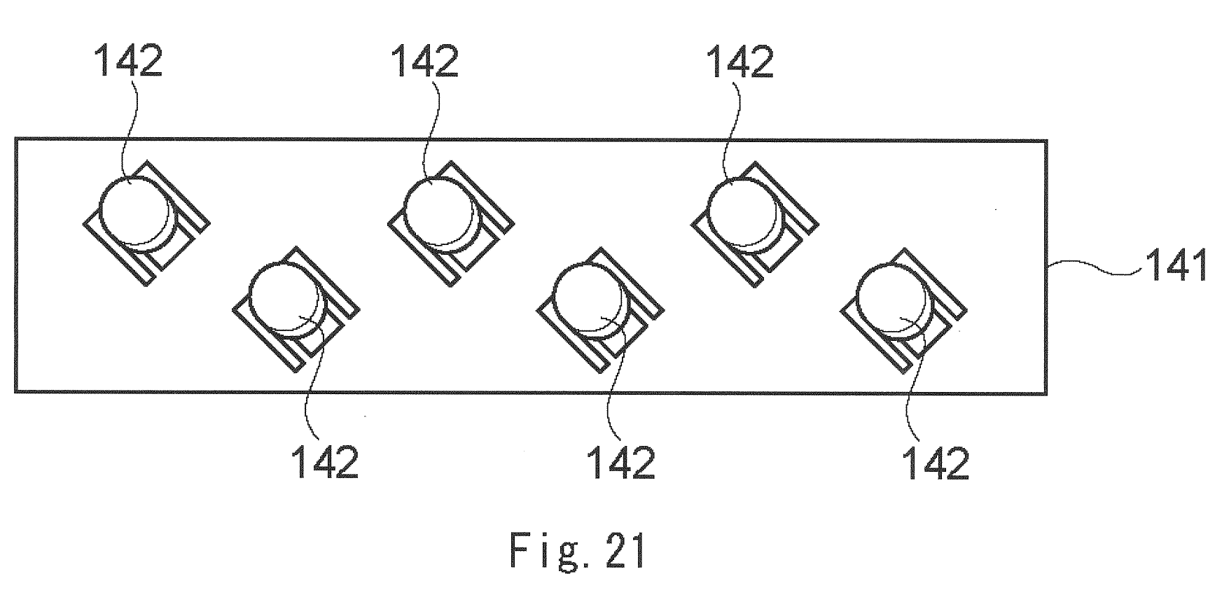

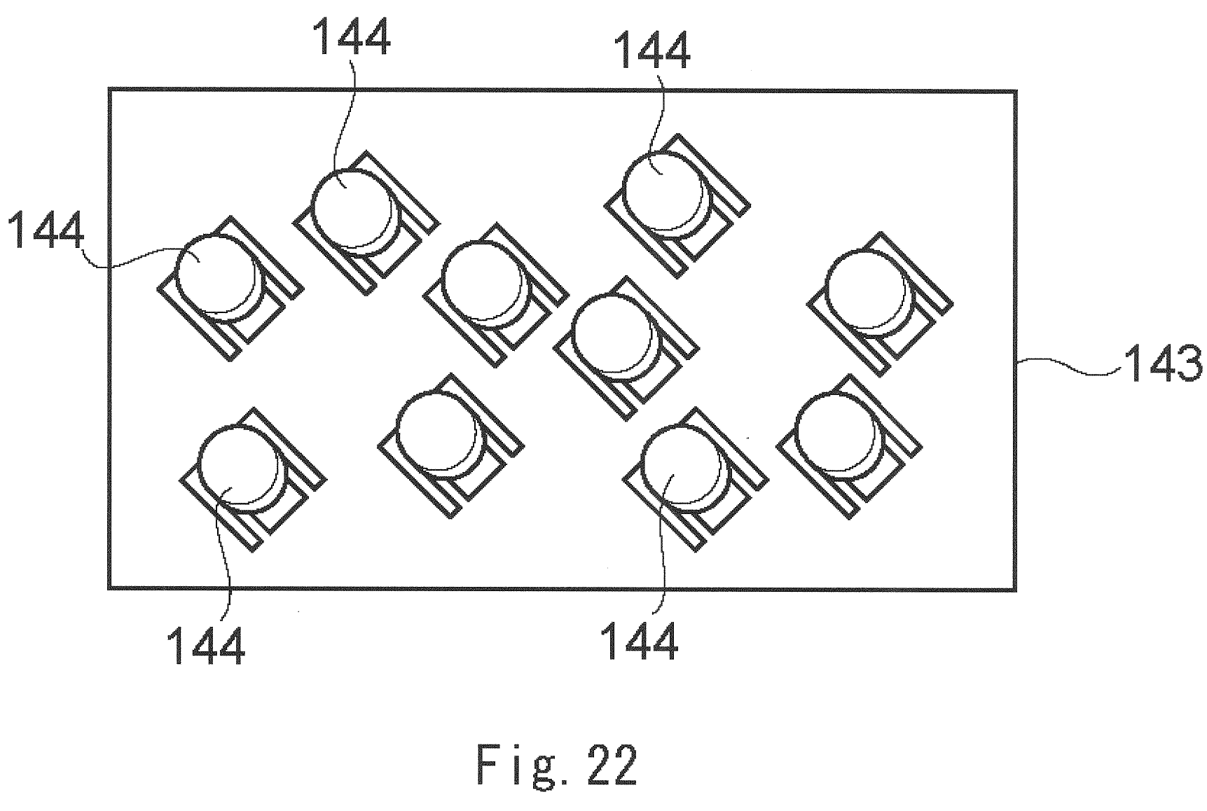

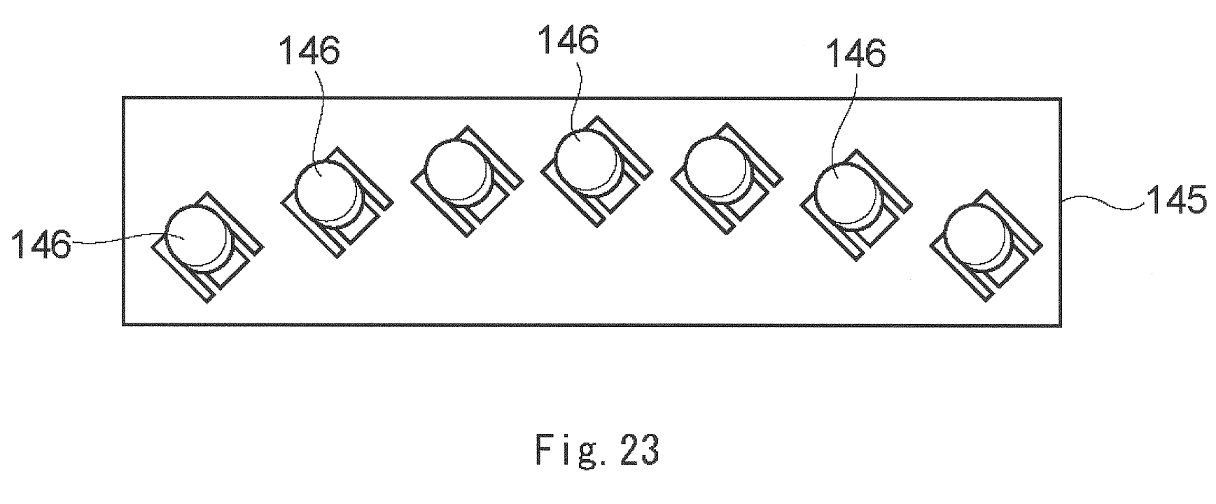

According to the foregoing embodiments, the number of LEDs, the arrangement pattern thereof and the combinations of directions of light emitting main axes can be properly determined in accordance with the kind of observation object and light-emitting characteristics of LEDs. For example, a plurality of LEDs 21, 22 and 23 may not be arranged in parallel to the X axis, or may not be arranged linearly, as the illuminating device 14 of the foregoing first embodiment. Specifically, as seen from an illuminating device 141 shown in FIG. 21, a plurality of LEDs 142 may be arranged like a zigzag. Further, as seen from an illuminating device 143 shown in FIG. 22, a plurality of LEDs 144 may be arranged at random. Furthermore, as seen from an illuminating device 145 shown in FIG. 23, a plurality of LEDs 142 may be arranged like an arc.

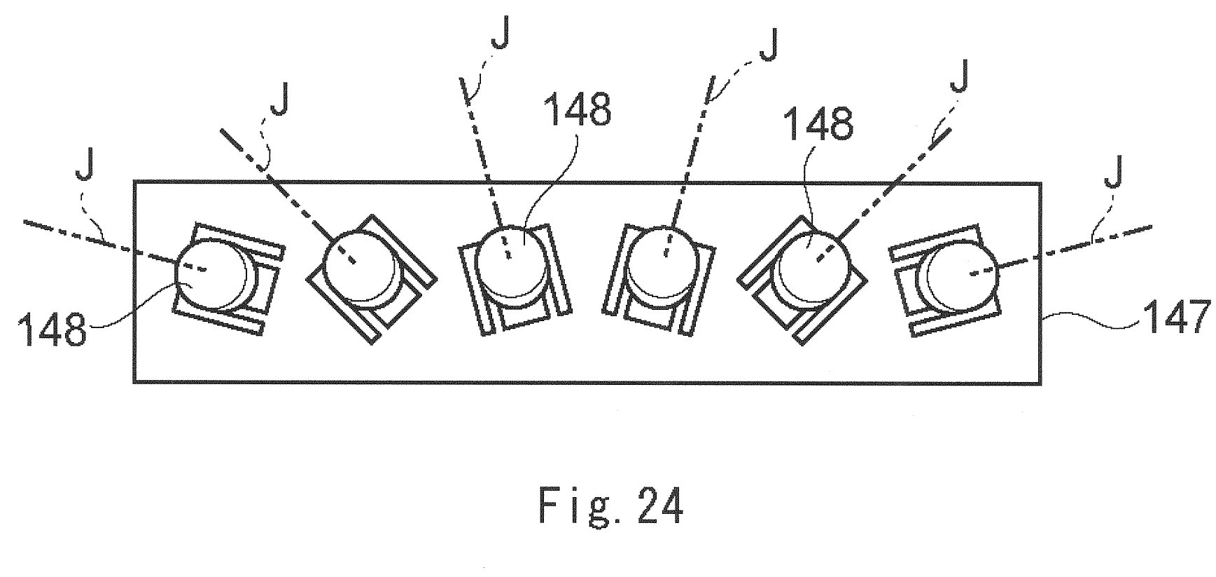

Moreover, a plurality of LEDs may not be arranged so that their light emitting axes L1, L2 and L3 are parallel to each other, as the illuminating device 14 of the foregoing first embodiment. For example, as seen from an illuminating device 147 shown in FIG. 24, the directions of light emitting main axes J may be changed every LED 148. In this case, an angle α made by an orthogonal projection of a light emitting main axis J to the X-Y plane and the X axis may be changed every LED 148. Moreover, an angle β made by an orthogonal projection of a light emitting main axis J to the Y-Z plane and the Y axis may be changed every LED 148.

According to the foregoing eighth embodiment, the illuminating 131 is rotated around the axial line parallel to the X axis, and thereby, each angle of light emitting main axes of LEDs 135, 136 and 137 is set. In this case, the following configuration may be employed. Specifically, the illuminating device may be rotated around an axial line parallel to the Y axis, an axial line parallel to the Z axis or axial lines except above, and thereby, each angle of light emitting main axes of LEDs may be set.

According to the foregoing first embodiment, the wafer 121 is placed on the attachment surface 11A so that one extending direction Sx of the circuit interconnect 122 is parallel to the X axis and the other extending direction Sx thereof is parallel to the Y axis. However, the present invention is not limited to above. For example, the wafer 121 may be placed so that one extending direction Sx of the circuit interconnect 122 is parallel to the Y axis and the other extending direction Sx thereof is parallel to the X axis. In this case, the arrangement of the illuminating device 14 with respect to the attachment surface 11A is changed in accordance with the direction of ID 123. For example, the illuminating device 14 is arranged so that the arrangement direction of LEDs 21, 22 and 23 is parallel to the Y axis.

An image analyzer including a microscope or high-precise camera may be used as the observing device 13 in the foregoing embodiments.

Other light emitting members such as a halogen lamp and a fiber illumination may be used in place of LEDs in the foregoing embodiments.

An observation object of the observing system of the foregoing embodiments is not limited to ID 123 on the wafer 121. For example, a two-dimensional matrix code marked on products may be used.

What is claimed is:

1. An illuminating device for irradiating light to an object in order to observe or shoot the object on an object placement plane by an observing device or camera device,
characterized by comprising:
a substrate;
a support member configured to support the substrate; and
a plurality of light emitting members arranged on a surface of the substrate,
wherein in a three-dimensional space defined by X and Y axes parallel to the object placement plane and crossing each other at right angles, and by a Z axis crossing at right angles with the X and Y axes, a direction of each light emitting member is set so that an angle made by an orthogonal projection of a light emitting main axis of each light emitting member to an X-Y plane and by the X axis is between 15 and 75 degrees, and an angle made by an orthogonal projection of a light emitting main axis of each light emitting member to a Y-Z plane and by the Y axis is between 0 and 75 degrees.

2. The illuminating device according to claim 1, characterized in that said plurality of light emitting members are arranged linearly on the surface of the substrate.

3. The illuminating device according to claim 1, characterized in that the light emitting main axes of the light emitting members are parallel to each other.

4. The illuminating device according to claim 1, characterized in that the light emitting members comprises a plurality of first-group light emitting members and a plurality of second-group light emitting members at least,
the first-group light emitting members are arranged linearly on the surface of the substrate,
the second-group light emitting members are arranged linearly on the surface of the substrate, and
the first- and second-group light emitting members are arranged in at least two lines on the surface of the substrate so that their arrangement directions are parallel.

5. The illuminating device according to claim 1, characterized in that the light emitting members comprises a plurality of first-group light emitting members and a plurality of second-group light emitting members at least,
the first-group light emitting members are arranged linearly on the surface of the substrate so that their light emitting main axes are parallel to each other,
the second-group light emitting members are arranged linearly on the surface of the substrate so that their light emitting main axes are parallel to each other,
the first- and second-group light emitting members are arranged in line on the surface of the substrate so that their arrangement directions coincide with each other, and
light emitting main axes of the first- and second-group light emitting members cross each other.

6. The illuminating device according to claim 4, characterized by further comprising:
control means for turning on the light emitting members every group.

7. The illuminating device according claim 1, characterized in that the light emitting members are light emitting diodes including a pair of leads for applying a voltage by itself, the surface of the substrate is formed with a pair of connection holes for inserting a pair of leads of each light emitting member, and an opening of each connection hole in a pair of connection hole is arranged on a straight line vertical to an orthogonal projection of each light emitting member to the X-Y plane.

8. The illuminating device according to claim 1, characterized in that the surface of the substrate is provided with a positioning member for determining a direction of each light emitting member, and each light emitting member is attached onto the surface of the substrate via the positioning member.

9. An illuminating system, characterized by including:
a plurality of illuminating device described in claim 1, which is arranged both sides or around an optical axis of the observing device or the camera directed to the object.

10. An illuminating system, characterized by including:
an illuminating device described in claim 1; and
a support member configured to rotatably support the illuminating device,
the illuminating device is rotated so that in the tree-dimensional space, a direction of each light emitting member is set so that an angle made by an orthogonal projection of a light emitting main axis of each light emitting member to an X-Y plane and by the X axis is between 15 and 75 degrees, or an angle made by an orthogonal projection of a light emitting main axis of each light emitting member to a Y-Z plane and by the Y axis is between 0 and 75 degrees.
